(19) United States
(12) Patent Application Publication
(10) Pub. No.: US 2013/0018818 A1
(43) Pub. Date: Jan. 17, 2013

(54) Systems And Methods For Investment Portfolio Management

(71) Applicant: Tapesh Yadav, Niwot, CO (US)

(72) Inventor: Tapesh Yadav, Niwot, CO (US)

(21) Appl. No.: 13/539,158

(22) Filed: Jun. 29, 2012

Related U.S. Application Data
(60) Provisional application No. 61/572,352, filed on Jul. 13, 2011.

(51) Int. Cl. G06Q 40/06

(52) U.S. Cl. 705/36 R

(57) ABSTRACT

Systems and methods for creating and managing investment portfolios are disclosed, These are useful to an individual investor, to investment advisors, as well as to professionally managed fund portfolios such as exchange traded funds, closed end funds, mutual funds, hedge funds, endowment funds, pension funds, wealth management funds, Other applications of taught methods and systems include product portfolio synthesis, process synthesis, and optimal internal allocation of capital in organizations.

### CROSS-REFERENCE TO RELATED APPLICATION

This application claims priority to U.S. Patent Provisional Application No. 61/572,352 which was filed on Jul. 13, 2011 entitled “Systems and Methods for Investment Portfolio Management,” the entire contents of which is hereby incorporated herein by reference for all purposes.

### TECHNICAL FIELD

Various embodiments of the present invention relates, in general to investment, and, more particularly, to systems and methods for creating and managing investment portfolios. The taught systems and methods are useful to an individual investor, to investment advisors, as well as to professionally managed fund portfolios such as but not limiting to portfolios of closed end funds (CEF), of mutual funds (MF), of exchange traded funds (ETF), of hedge fluids (HF), of stocks, of bonds, of indices, of commodities, of options, of futures, of swaps, of precious metals, of real estate, of endowment funds, of family offices, of corporate capital, of private equity, of sovereign wealth funds, of bank capital, of venture capital, and the like, and various combinations thereof.

### BACKGROUND

Investment of surplus cash, savings, new wealth and inherited wealth is as old as human history. Systematic investment, portfolio theory and capital markets are, however, of more recent origins.

Morkowitz developed, the basic principles of portfolio theory in the 1950s (Markowitz H. M., “Portfolio Selection”, The Journal of Finance, 7:77-91, 1952); his theory revealed a systematic foundation for investor as an economic agent acting under uncertainty, and acting to achieve highest return for a risk he or she is willing to bear. Markowitz identified variance of a portfolio's market value, or equivalency portfolio's standard deviation, as a measure of risk for the investor. Markowitz further formalized and developed this foundation as mean-variance analysis, efficient frontier and quadratic optimization method (Markowitz H. M., Portfolio Selection: Efficient Diversification of Investments, New York, John Wiley & Sons Inc, 1959).

Building upon Markowitz's work, Sharpe developed the basic principles for pricing of capital assets in competitive markets (Sharpe W, “Capital Asset Prices: A Theory of Market Equilibrium Under Conditions of Risk”, Journal of Finance, 19:425-442, 1964). These principles have since then come to be known as Capital Asset Pricing Model (CAPM), and variants thereof. Sharpe's work on market equilibrium and CAPM explicitly assumes investors follow the prescriptions of Markowitz' portfolio theory, that is, each investor seeks a portfolio to maximize his or her utility, wherein investor's utility is risk-adjusted expected return of the portfolio at any given one period at a time. Furthermore, Sharpe teaches that a portfolio's risk depends on both the variance of the market return of component securities, and the covariances among securities. In a parsimonious mathematical characterization of an investor, this can be stated as a

quadratic optimization problem:

$$Maximize \\ {U}_{k} = {E}_{k} - \frac{1}{{τ}_{k}} {V}_{k} \qquad ( 1 )$$

Subject to the constraint ΣⱼXⱼₖ=1 (2)

Wherein, Uₖ is investor k's utility, Eₖ is the expected, return on investor k's portfolio, Vₖ is the variance of the portfolio, τₖ is his or her risk tolerance, Xⱼₖ represents the proportion of investor k's portfolio invested in asset j, and Σⱼ represents summation over all investable assets j.

Sharpe's work was followed by various parallel teachings, variants and extensions to CAPM. For example, Lintner focused on investor returns in real terms (Lintner J., “The Aggregation of Investors' Diverse Judgments and Preferences in Purely Competitive Markets”, Review of Economics and Statistics, 47:13-37, 1969), Brennan teaches an extension to incorporate the effect of taxes on investor return (Brennan M. J., “Taxes, Market Valuation and Corporate Financial Policy”, National Tax Journal, December:417-427, 1970), Merton teaches a method to incorporate future investment opportunities for the investor (Merton R., “An Intertemporal Capital Asset Pricing Model”, Econometrica, 41:867-887, 1973), Levy teaches an extension to incorporate the effect of transaction costs on investor return (Levy H., “Equilibrium in an Imperfect Market: A Constraint on the Number of Securities in a Portfolio”, American Economic Review, 68:643-658, 1978), Lucas teaches method incorporating expected utilities of current and future consumption (Lucas R., “Asset Prices in an Exchange Economy”, Econometrica, 46:1429-1445, 1978), Breeden teaches method to incorporate an investor's preference for consumption (Breeden D., “An Intertemporal Asset Pricing Model with Stochastic Consumption and Investment Opportunities”, Journal of Financial Economics, 7:265-296, 1979), and Markowitz teaches a version that incorporates certain limitations on short sales (Markowitz, H. M., “Risk Adjustment”, Journal of Accounting Auditing and Finance, 5:213-225, 1990). All these versions teach variance of a portfolio, or equivalency portfolio's volatility, as a measure of risk for the investor.

CAPM is a utility-based financial economics theory. A complementary theory to CAPM is the arbitrage-based theory. Prominent arbitrage-based theories are the Black-Scholes model (Black F. and M. Scholes, “The Pricing of Options and Corporate Liabilities”, Journal of Political Economy, 81:637-654, 1973), and the Arbitrage Pricing Theory taught by Ross (Ross S., “Arbitrage Theory of Capital Asset Pricing, Journal of Economic Theory, 13:341-360, 1976). Such complementary models for financial economics, in theory and investment practice, consider variance and volatility—actual or implied—as the measure of risk for all types of securities.

CAPM teachings are intuitively pleasing and attractive, yet its real life empirical record has been poor in United States financial markets and other markets. Fama and French suggest these empirical problems may reflect theoretical failings, the result of many simplifying assumptions; and, these failings may also be the result of difficulties in implementing valid tests of the model, despite intensive worldwide effort to do so (Fama E. F. and K. R. French, “The Capital Asset Pricing Model: Theory and Evidence”, Journal of Economic Perspectives, 18-3:25-46, 2004). Furthermore, Fama and French suggest that to those who conclude the empirical failures of the CAPM as fatal, two competing parties emerge: on one side are the behaviorists who suggest markets are driven by irrational pricing of securities, the other side are the rigorists who suggest CAPM return variance misses important dimensions of risk, that market beta is not a complete description of an asset's risk, and a more rigorous model may help CAPM improve its empirical record.

Pillai in U.S. Pat. No. 7,502,756 teaches an approach to portfolio optimization. There Pillai, for example, in column 1, lines 24-37, too considers portfolio volatility as a measure of investor risk.

### SUMMARY

Various embodiments of present invention include systems and methods to create and manage investment portfolios comprising one or more assets. The embodiments taught are useful to an individual investor, to investment advisors, as well as to funds.

Some embodiments of the present invention include methods and systems to invest capital optimally amongst assets. In at least one embodiment, a method and a system is taught using which an investor or investment advisor or fund manager or corporation is able to optimally invest available cash—of an investor, group of investors, or a fund—to create a portfolio.

One or more embodiments of the present invention include methods and systems to add new capital to an existing portfolio, optimally distribute the new capital amongst existing assets of the portfolio, or optimally distribute the new capital to assets not currently in the portfolio thereby expanding the portfolio, or both.

Various embodiments of the present invention include methods and systems to redeem or withdraw capital from an existing portfolio by optimally selling existing assets of the portfolio to meet cash needs of the investor, group of investors, or a fund.

Some embodiments of the present invention include methods and systems to monitor the performance of an existing portfolio.

Several embodiments of the present invention include methods and systems to optimally re-distribute the allocations amongst existing assets of the portfolio, or optimally re-distribute the allocations from currently owned assets in the portfolio to assets not currently in the portfolio, or both.

One or more embodiments of the present invention include methods and systems to optimally create and manage an investment portfolio comprising investor's periodic income and cash flow needs.

Various embodiments of the present invention include methods and systems to optimally create and manage an investment portfolio comprising investor's tax situation. In at least another embodiment of the present invention a method and a system is taught to optimally create and manage an investment portfolio comprising a fund's unique tax objectives.

Several embodiments of the present invention include methods and systems to optimally create and manage an investment portfolio when an investor is concerned with two different types of constraints. In one embodiment of the present invention are methods and systems to optimally create and manage an investment portfolio when an investor is concerned with three different types of constraints. Another embodiment of the present invention are methods and systems to optimally create and manage an investment portfolio when an investor is concerned with four different types of constraints. In one embodiment of the present invention are methods and systems to optimally create and manage an investment portfolio when an investor is concerned with five or more different types of constraints.

Some embodiments of the present invention include methods and systems to optimally create and manage an investment portfolio when an investor, or fund, considers volatility as a measure of opportunity, rather than considering volatility as a measure of risk as has been taught in prior art.

One or more embodiments of the present invention include methods and systems to optimize an investor's or fund's expected after-tax returns on capital invested in a portfolio of assets.

Various embodiments of the present invention include methods and systems to optimally create and manage an investment portfolio comprising investor's or fund's unique transaction costs.

Some embodiments of the present invention include a computer-implemented method for creating and managing a portfolio of assets for an investor. The method can include providing an optimization problem comprising at least one objective function and at least two constraints selected from the group consisting of capital availability constraint, volatility constraint, style constraint, correlation constraint, discount constraint, information ratio constraint, diversification constraint, fundamental performance constraint, and miscellaneous constraint. Using a processor, the optimization problem can be solved to generate a desired allocation of assets within the portfolio of assets. The method can then allocate the assets within the portfolio of assets in accordance with the desired allocation of assets.

Various embodiments of the present invention include a system for creating and managing a portfolio of assets. The system can include a processor, an allocation module, and a communication module. The allocation module may be configured to use the processor to solve an optimization problem to generate a desired allocation within the portfolio of assets. The optimization problem may include at least one objective function and at least two constraints selected, from the group consisting of capital availability constraint, volatility constraint, style constraint, correlation constraint, discount constraint, information ratio constraint, diversification constraint, fundamental performance constraint, and miscellaneous constraint. The communications module can receive the desired allocation from the allocation module and request the assets within the portfolio of assets be allocated in accordance with the desired allocation.

In one or more embodiments of the present invention, the system can also include an interface portal and a conversion module. The interface portal may be configured to receive investment goals and guidelines for the portfolio of assets. The conversion module may be configured to convert the investment goals and guidelines the at least one objective function and at least two constraints.

Various embodiments of the present invention provide for a computer-readable storage medium containing a set of instructions capable of causing one or more processors to solve, using the one or more processors, an optimization problem to generate a desired allocation of assets within the portfolio of assets. The optimization problem may comprise at least one objective function and at least two constraints selected from the group consisting of capital availability constraint, volatility constraint, style constraint, correlation constraint, discount constraint, information ratio constraint, diversification constraint, fundamental performance constraint, and miscellaneous constraint. The set of instruction may be further capable of causing the one or more processors to allocate the assets within the portfolio of assets according to the desired allocation of assets.

Some embodiments of the present invention include methods and systems to optimally create and manage an investment portfolio comprising investor's unique ability and desire to bear risk. In at least another embodiment of the present invention a method, and a system is taught to optimally create and manage an investment portfolio comprising a fund's unique ability and desire to bear risk.

Various embodiments of the present invention include methods and systems to optimally create and manage an investment portfolio comprising investor's ability and desire to borrow or loan capital at a unique rate for investment purposes. In at least another embodiment of the present invention a method and a system is taught to optimally create and manage an investment portfolio comprising a fund's ability and desire to leverage or deleverage.

Some embodiments of the present invention include methods and systems to simplify efficient allocation of capital into wide range of assets. Such efficient allocation is difficult for an investor, because of evolving needs and constraints faced by an investor. This problem is exacerbated by the fact that available assets continue to expand as world, economy grows and becomes more interconnected. For example, over 600 closed end funds trade just in the United States exchanges, and well over 1,000 closed end funds trade worldwide. Similarly, in 2010, over 1,000 exchange traded, funds (ETFs) traded globally, over 69,000 mutual funds (MPs) traded globally, over 40,000 stocks traded, globally on major stock exchanges belonging to World Federation of Exchanges. If we include options, futures, metals, real estate, private placements, trusts, hedge funds, bonds, senior loans, preferred securities, derivatives and other assets, the number of assets available to investors exceed the number of minutes in a year. This number is likely to increase with time and with growth of global economy. Detailed analysis and study of fundamentals of each asset, then selection, creation and management of portfolio is therefore difficult. The present invention provides methods and systems to create and manage portfolio from large number of assets and wide range of assets.

The embodiments of the present invention include methods and systems to create and manage funds. Such efficient allocation is difficult for funds, because of the fact that numerous assets are available, and the number of available assets increases as world economy grows and becomes more interconnected. To illustrate, over 200municipal closed end funds exist in the United States, with over $70 billion in managed assets. These municipal closed end funds are offered by companies such as Nuveen, Blaekrock, Invesco, Eaton Vance, PIMCO and others. To meet their investment objectives and comply with their fundamental and non-fundamental investment policies, each of these municipal closed end funds must screen and then select from over 25,000 rated municipal bond, issuers, over 25,000 unrated municipal bond issuers, and well over 50,000 derivatives to hedge the effects of factors that affect portfolio's earnings, net asset value and such performance measures; illustration of such factors include but do not limit to inflation and interest rate changes. Like municipal closed end. funds, other funds face similarly daunting task of capital allocation, amongst large number of assets and over wide range of assets, in ever changing market conditions and evolving regulatory compliance environment. The present invention provides methods and systems to create and manage portfolio for funds from large number of assets and wide range of assets over time, in ever changing market conditions.

### BRIEF DESCRIPTION OF THE DRAWINGS

Embodiments of the present invention will be described and explained through the use of the accompanying drawings in which:

FIG. 1 is an exemplary system of the present invention for an investor or fund to optimally create and manage an investment portfolio.

FIG. 2 is an embodiment of the system of the present invention shown in FIG. 1,

FIG. 3 is another embodiment of the system for implementing the present invention through the architecture shown in FIG. 1.

The drawings have not necessarily been drawn to scale. For example, the dimensions of some of the elements in the figures may be expanded or reduced to help improve the understanding of the embodiments of the present invention. Similarly, some components and/or operations may be separated into different blocks or combined into a single block for the purposes of discussion of some of the embodiments of the present invention. Moreover, while the invention is amenable to various modifications and alternative forms, specific embodiments have been shown by way of example in the drawings and are described in detail below. The intention, however, is not to limit the invention to the particular embodiments described. On the contrary, the invention is intended to cover ail modifications, equivalents, and alternatives failing within the scope of the invention as defined by the appended claims.

### DETAILED DESCRIPTION

### Definitions

Asset, as the term used herein, is any property or item of value owned by an individual or collection of individuals or an organization. The term encompasses, but is not limited to cash, liquid instruments, money market accounts, plants, equipment, real estate, infrastructure, commodities, grains, oil, fuel, reserves, intangibles such as brand and patents, precious metals, any non-fungible item of financial value such as art or cut diamond or historical artifact, any fungible negotiable financial instrument representing financial value, stocks, shares, preferred stocks, common stocks, bonds, permanent interest-bearing shares, perpetual subordinated bonds, sovereign bonds, corporate bonds, municipal bonds, agency bonds, revenue bonds, equity, securities of both U.S. and non-U.S. issuers, depositary receipts, investment trust securities, convertible securities, contingent convertible securities, hybrid securities, arbitrage securities, rolling securities, marginable securities, illiquid securities, synthetic securities, partnership interests such as but not limiting to master limited partnership interests, fixed or variable rate debt obligations, bills, notes, debentures, senior loans, subordinated loans, line of credit instruments, open end funds, closed end funds, exchange traded funds, warrants, options, futures, swaps, swaptions, caps, floors, collars, fixed income instruments, money market instruments, structured securities, zero coupon securities, inflation adjusted coupon securities, tax exempt securities, taxed securities, tax credit securities, fixed coupon securities, floating rate securities, floored rate adjustable securities, restricted securities, private placement securities, investment company securities, utility securities, trust preferred securities, long term equity anticipation securities, contracts, currency roll securities, cross currency and international instruments such as but not limited to Eurodollar Instruments and Brady bonds and Yankee bonds, foreign currencies, forward contracts, stock indices, stock index futures, dividend swap securities, certificates of deposits, derivatives, reverse repurchase agreements, and the like. The term includes combinations of one or more of these, and derivatives thereof, and securities comprising of one or more of these, and trusts comprising of one or more of these. The term includes any property or item of value that is exchanged privately or with the help of another organization such as a bank or through a stock exchange such as one that is a member of World Federation of Exchanges—Federation Internationale des Bourses de Valeur (FIBV). The term includes but is not limited to securities that are issued in any non-United. States market, known by other names or other languages or both, and are similar or equivalent in their nature or scope to those enumerated above.

Investor, as the term used herein, is any individual acting is his or her capacity, or a collection of related or unrelated individuals, or one or more individuals acting with advice from investment advisor, or one or more agents or representative or investment advisors or financial professionals, or an office or any legally appointed, custodian or any legally registered, organization created or hired with certain investment goals and guidelines. The term includes in its scope any and all investment goals and guidelines comprising any and all assets. Investor, as the term is used herein in various embodiments of present invention, includes but is not limited to funds with investment goals and investment policies.

Fund, as the term used herein, is any legally registered organization that invests the money it receives from one investor, or two or more investors on a collective basis, and each investor shares in the profits and losses, after expenses, in proportion to the investor's interest in the organization, or in accordance with a contractually agreed formula. The term encompasses but is not limited to closed-end funds (CEF), mutual funds (MF), unit investment trust funds (UIT), exchange traded funds (ETF), hedge funds, money market funds, trust funds, investment funds, pension funds, retirement funds, actively managed funds, passively managed funds, endowment funds, family office funds, corporate funds including corporate investment funds, private equity funds, sovereign wealth funds, venture capital funds, fund of funds, and the like, and various combinations thereof. The term includes organization registered or domiciled in any jurisdiction in the world with or without a tax treaty with the United States or any member of the European Union or Singapore or Hong Kong or Switzerland or Bailiwick of Jersey or Bailiwick of Guernsey or Isle of Man or Cayman Islands. The term includes organization that at any time in its lawful existence may purchase some assets or sell some assets or borrow some assets or loan some assets or pledge some assets or the like and conduct some or all such investment activity privately or with the help of another organization such as a bank or through a stock exchange such as one that is a member of Federation Internationale des Bourses de Valeur. The term includes organization, legally registered anywhere in the world, known by other names or in other languages or both, and is similar or equivalent in its structure and goals to those enumerated above.

Computer, as the term used herein, includes any form of computer, one or more computer systems, any programmable device, and any system comprising of a programmable device. The term includes system when deployed either alone or in combination, a personal computer (PC), server-based computer, main frame, server, microcomputer, minicomputer, laptop, personal data assistant (PDA), cellular phone, pager, processor, including wireless and/or wired varieties thereof, and/or any other computerized device capable of configuration for processing data for standalone application and/or over a networked medium or media. The term as used herein may include operatively associated memory for storing certain software applications used in obtaining, processing, storing and/or communicating data. Such memory can be internal, external, remote or local with respect to its operatively associated computer or computer system. Memory may also include any means for storing software or other instructions including, for example and without limitation, a hard disk, a solid state disk, an optical disk, floppy disk, ROM (read only memory), RAM (random access memory), PROM (programmable ROM), EEPROM (extended erasable PROM), and/or other like computer-readable media. The term as used herein may include other components, accessories, software and anything that enables investors of different age, different education background, different languages, different physical abilities and disabilities to practice the present invention.

More optimal solution, as the term used herein, includes any solution that better meets the objectives of an investor while satisfying all constraints relevant to the investor.

The phrases “in some embodiments,” “according to various embodiments,” “in the embodiments shown,” “in other embodiments,” “in one embodiment,” “the embodiments,” “one or more embodiments,” and the like generally mean the particular feature, structure, or characteristic following the phrase is included in at least one embodiment of the present invention, and may be included, in more than one embodiment of the present invention. In addition, such phrases do not necessarily refer to the same embodiments or to different embodiments.

If the specification states a component or feature “may”, “can”, “could”, or “might” be included or have a characteristic, that particular component or feature is not required to be included or have the characteristic.

### Description

Various embodiments of the present invention include systems and methods to create and manage investment portfolios comprising one or more assets. The embodiments taught are useful to an individual investor, to investment advisors, as well as to funds. Unlike the prior art wherein volatility of one or more assets and the portfolio is considered a risk, in at least one embodiment of the present invention methods are described wherein volatility is considered an opportunity. Unlike the prior art wherein risk is mathematically modeled with variance and covariance from unpredictable asset price movements in the market, in at least one embodiment of the present invention methods are described wherein risk is mathematically modeled as the likelihood of permanent impairment of capital invested in an asset. Unlike some versions of prior art wherein investment objective includes one or more parameters comprising volatility-driven risk premium, in at least one embodiment of the present invention methods are described wherein investment objective excludes volatility-driven risk premium and the investor's risk appetite is modeled as a constraint.

At least one embodiment of the invention provides a method of converting investment goals and guidelines as a set of mathematical objective functions and a combination of many mathematical constraints, constants, independent variables, and investor specific parameters. These constants and independent variables are continuously updated to incorporate the current facts and reality, with integrated systems such as but not limiting to data sourced from internet-enabled real time market data and real time economic fundamentals. The investor specific parameters too are updated as and when appropriate to reflect investor requirements such as need to withdraw cash to meet expenses or pay taxes or such, government mandated withdrawal of funds from tax deferred investment account, addition of cash into the investment account and investor's need to identify best allocation of the capital into available assets, change in investor's risk appetite because of reasons such as unexpected family medical emergency or birth of children or grandchildren or the like, desire to donate to one or more philanthropic causes, or other such parameters unique to each investor. With constants, investor specific parameters and variables updated, the objective functions and constraints are solved by mathematical methods and heuristics to obtain a more optimal solution. The solution provides the investor the optimal allocation of available capital into available assets, and such solution is a combination of assets to be sold, assets to be bought, assets to be retained, and assets to be disposed. This solution is implemented by the investor or fund, by manual means, or with assistance of computers or trading platforms or the like, or with complete automation such as algorithmic trading systems and the like.

With time, facts and reality change. With changing reality and facts, in the taught embodiments, the methods and systems repeatedly update, then repeatedly solve, the investor-specific or fund-specific mathematical objective functions and a combination of many mathematical constraints, constants, investor specific parameters and independent variables. In at least one embodiment of the present invention, the changing financial market and economic reality, or the changing investment goals and guidelines of an investor, or both, change the comprehensive mathematical objective functions and the combination of many mathematical constraints, constants, investor specific parameters and independent variables; with every changed set of objectives, constraints, constants and variables, systems taught herein solve the combined, set of objectives, constraints, constants, parameters and variables using computer, a network of computers, other computing resources, and the like.

### The Systems

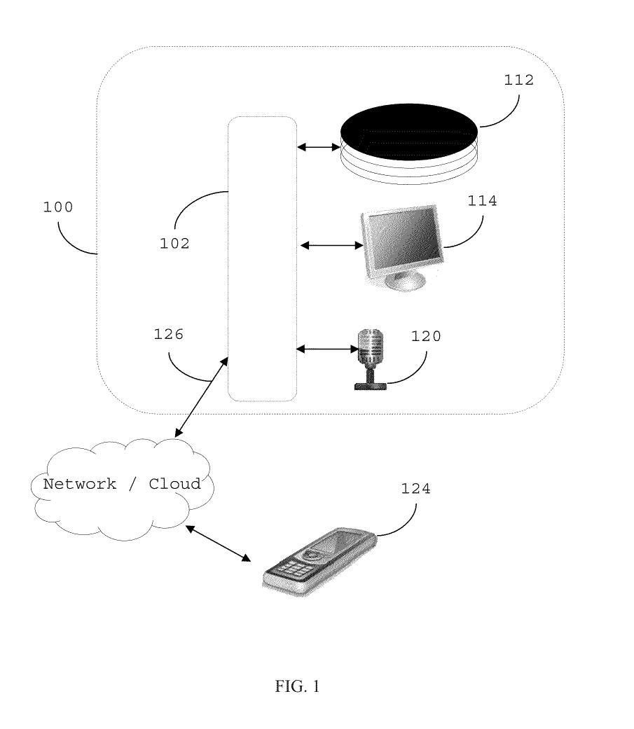

An embodiment of systems suitable for carrying out the invention is illustrated in FIG. 1. Such a system for creating and managing investment portfolios 100 is assembled around a computer 102 having so-called desktop computer architecture; alternatively, other devices may be used, such as but not limiting to a tablets, mobile phones, minicomputers, workstations, diskless network-connected computers, kiosks, electronic books. These devices may operate using battery, plugged in electrical power, light or any other energy source.

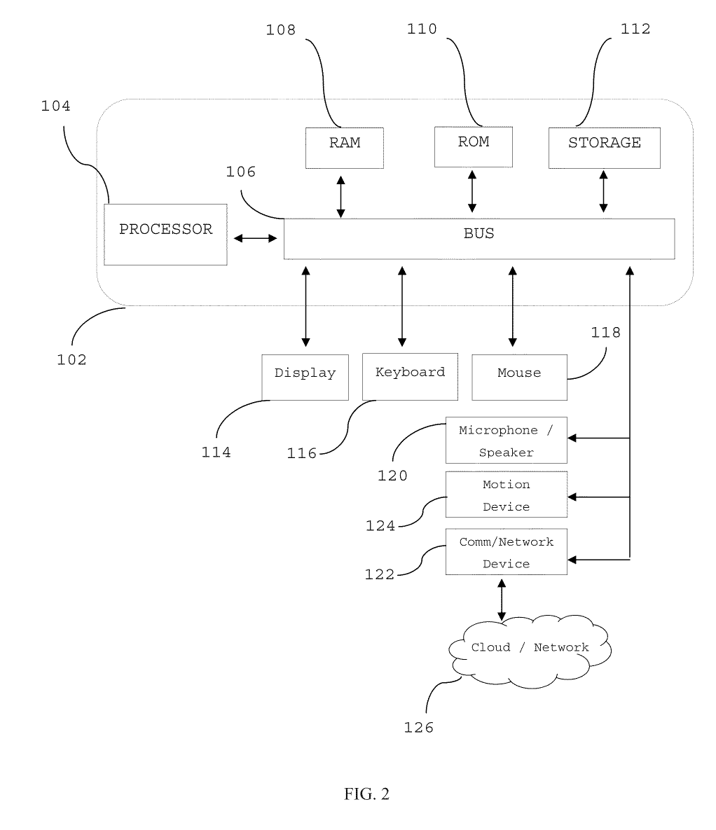

Referring to FIG. 2, a highly schematic internal architecture of one of many embodiments of the present invention, the desktop computer 102 is shown. In one embodiment, the computer 102 comprises of one or more microprocessors 104, one or more of which comprise memory cache (not shown), one or more of which comprise of serial or parallel core architecture with or without hyper-threading, and each of these microprocessors may be associated with one or more mathematics or other special-purpose coprocessors (not shown). The microprocessors 104 are connected by a bus structure 106 to the various other components of the computer 102. The present invention, when implemented in the embodiment of a desktop computer, is preferably implemented with two or more processor cores. Various embodiments include desktops comprising Pentium, Itanium, Xeon, Celeron, Core, Nehalem and Atom microprocessors from Intel®. Other embodiments include desktops comprising Phenom, Athlon, Sempron, Opteron, Geode, Turion and Neo microprocessors from AMD®. Further embodiments include desktops comprising of precision built microprocessors at 45 nm, 32 nm, 22 nm, 16 nm, 11 nm, 8 nm, 6 nm, 4 nm node and such.

A schematic representation of bus 106 is shown in FIG. 2 as a simplified structure, but in practice, as is known to those in the art, there usually are several buses and communication pathways 106, operating at different speeds and having different purposes. Further, bus 106 may be segmented and controlled by respective bus controllers. Other variations and configurations may be deployed.

Computer 102 may have one or more random access memory units 108 connected to the bus 106. RAM 108 (which may be DDR SDRAM, DRAM, SDRAM, TRAM, ZRAM, TTRAM or other blown types) may comprise of desktop's operating software of and executable instructions for one or more special applications designed to practice the present invention. Computer 102 may comprise of non-volatile read-only memory (ROM) 110 for storing software which persist after the computer 102 is shut down. ROM 110 can comprise of electrically programmable read-only memory (EPROM), electrically erasable and programmable read-only memory (EEPROM) of either flash or nonflash varieties, or FeRAM, PRAM, CBRAM, SONOS, RRAM, NRAM, Millipede, or combinations, or any other form of non-volatile memory.

In a typical architecture, a computer program suitable for carrying out the invention will be stored on a device 112, such as a solid state disk or optical disk or magnetic hard, drive or flash drive or any other similar device. The historical and current data used for portfolio creation and management will typically exist as a database on device 112. In another embodiment, the database resides on an external disk, or separate database server, or internet cloud medium, and be accessed remotely through a wired, or wireless network. Bus 106 illustrates connection of mass storage device 112 to other system parts.

The computer 102 is connected to various peripheral devices used to communicate with an investor, such as touchscreen or display 114, keyboard 116, mouse or touchpad 118, speech-device 120, and motion-device 124. The computer 102 also uses a communications device 122 such as a modem or a wireless card or an ethernet card or optical card to communicate to other systems such as but not limiting to other computers, or internet devices, or data feed sources, or database resources, or combinations. This communication occurs over a linked network 126, which for illustration may be the Internet or Intranet or web of devices connected by fibers or wires or wirelessly.

The investor inputs various objectives, constraints, parameters, constants and such information into computer 102 by means of the touchscreen or display 114, keyboard 116, mouse or pad 118, talking and listening with speech-device 120 and interactive motion with motion-device 124. The computer may assist the investor by providing hardware and software-enabled interface that simplifies information input, that cross checks data consistency, that prevents errors, that formulates the questions and directions driven by heuristics or investor's profile, that accelerate information entry by displaying possible or likely inputs, or such, and combinations. This information and investor instructions are then entered into the method embodiments of the present invention, solved within the desktop, the results displayed, to the investor. In another embodiment, the information and investor instructions of the investor are conveyed over a communications link to another computer, or a network of computers, or to an internet-connected, cloud computing resource (not shown). These communications linked computers then process the investor information and instructions, solve the portfolio creation and portfolio management problem, and return the results over the communications link to computer 102, those results are then communicated to the investor by the touchscreen or display 114, or other means. In another embodiment, the results are communicated, to the investor over speaker by the speech-device 120, or sensory motion with motion-device 120, or such devices, or combinations thereof. The former embodiment is useful to investors who have visual limitations, are blind, or are unable to read because of temporary injury or other reasons. The latter embodiment is useful to investors who have visual and auditory limitations, are blind and deaf, or are unable to read and hear because of temporary injury or other reasons.

In one embodiment, attribute mapping routines are used to convert investor obtained, information and instructions into one consistent format for storage in a database. The database stores investor preferences, investor instructions and information, investor transaction and portfolio performance history, tax and accounting rules data, exchange standards and legal compliance data, securities exchange compliance data, transaction cost data, market data, and calculation results. All this information is in a single database or other storage means, or distributed across multiple databases or other storage means. In one embodiment, the database is implemented in ways that ensure integrity and continued availability of all data in case of accidental failure of database devices; an illustration of such reliable database implementation is mirroring, redundant arrays, and continuous backup systems. In another embodiment, the database and methods taught here are implemented in ways that ensure minimum clicks and effort for the investor, an intuitive way to enter his or her needs and an intuitive way to understand the solutions from methods taught herein and an intuitive way to implement the more optimal solutions.

In an embodiment, the computer 102 comprises of or is linked to trading system and method, enabling the investor to accept the results from the present invention, and thereafter enable the computer 102 or the linked trading system to issue orders to purchase or sell assets according to the results communicated to the investor by computer 102. The issued orders may be electronic, an email, sent to a printer, a fax, a phone call, manual, or any such means convenient and accepted by a brokerage, market maker, clearinghouse, exchange or parties with the ability to enter into a binding transaction of one or more assets.

In one embodiment, all information exchange, instructions, computations and transactions are recorded, processed and made over secure systems and communication paths, with or without encryption. Such secure systems may comprise of login interface, passwords, security questions, personal verification methods such as but not limiting to retina scan or fingerprint recognition methods, device location identification, device serial number identification, wireless key, card scan, and the like. These may be manual or automatic, hardware or software enabled.

The computer 102 may include a browser or web server or both, providing a web site, on which is displayed an interface for the investor to enter information and instructions, an interface for the investor to start calculations, an interface to show to the investor that the calculations in accordance to methods of the present invention are in progress, as well as pages with the results produced by the methods of the present invention. The results may be presented in various forms, such as but not limiting to a display as tables, or as graphs of choices selectable by an investor, along with a list of assets that the investor should sell and assets that the investor should buy. The results may also be displayed with secondary information such as the effect of each presented option on investor's objectives, constraints and parameters. The display may also present sensitivity results. These results may be accessible, either remotely (as shown) or non-remotely (not shown) by mobile phones and tablets and other investor's device 124 of FIG. 1. In another embodiment, the results may be presented on two or more displays or two or more systems, thereby enabling the investor to work in teams, or with investment advisors, or with legal counsels, or with tax advisors, or the like, and combinations thereof.

Various embodiments of the present invention may be implemented in systems designed to provide both distributed, desktop, front-office capabilities for large numbers of users, as well as middle-office batch capabilities to support portfolio return and risk management. Such systems are also preferably computationally efficient and scalable to the largest portfolios. The portfolio value may be less than a thousand US dollars in some embodiments, less than a million US dollars in other embodiments, less than a billion US dollars in other embodiments, less than a trillion US dollars in other embodiments, more than 1 trillion US dollars in yet other embodiments (each adjusted for inflation to Jan. 1, 2011 US dollars). In some embodiments of the invention, the systems comprise key decision-support tools that include the ability to research, analyze and determine the fundamentals of each asset and factors affecting the asset's current and future performance. The system may be adapted to support pricing, valuation, tax affects, credit profile, performance simulation and reporting capabilities for each asset, and assets in combination. The system may be adapted to provide the facility to serve a single investor or multiple investors concurrently.

Another embodiment of a system to practice the present invention is any wired or wireless mobile device such as a wireless phone or wireless tablet device. These mobile systems may have features and details explained above for desktop embodiments. As examples, but not as limitations, mobile systems may offer features similar to desktop systems, features such as background refresh of market data, automatic calculations in the background on the mobile device or on an external device or on cloud computing devices, push of results to the mobile devices in possession of the investor, alert signals or alarms for the investors when certain parameters of investors are met, interfaces for quickly issuing trade orders from the mobile device, interfaces for confirming of executed trades, monitoring of portfolio performance, reminders of portfolio events such as ex dividend date, merger date, corporate action date, availability of cash balance, margin calls, change in loan rate or margin requirements, drop in a parameter beyond a pre-set alert range, and the like.

Another embodiment of a system to practice the present invention is any device comprising an auto-delete routine after the investor has used the system. In these systems, some or all data used or downloaded or calculated, by the investor is simply erased or securely deleted by the software or hardware on the device after the investor logs off the device.

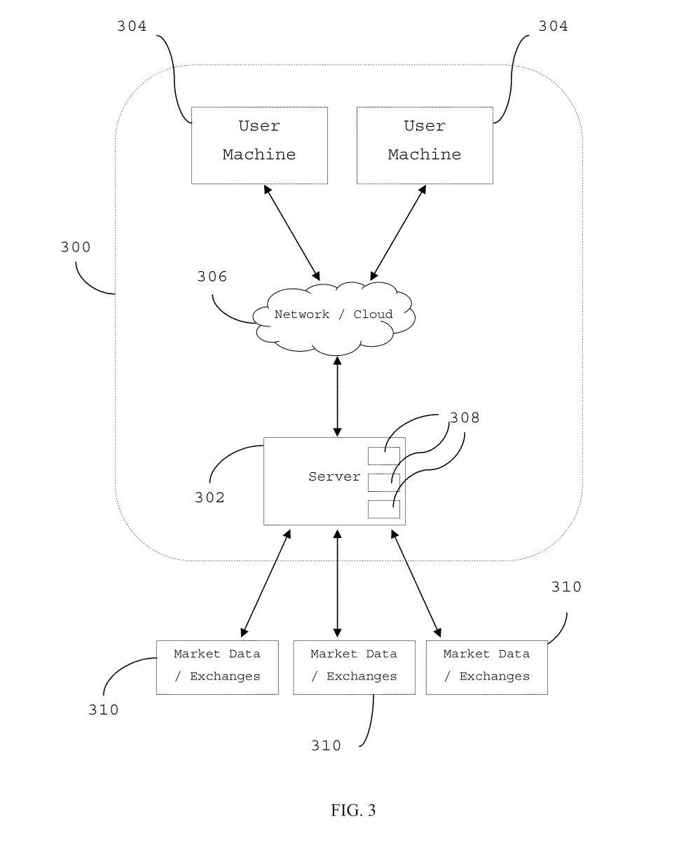

FIG. 3 illustrates another embodiment of a computerized system 300 for implementing the present invention. The system 300 may include one or more servers 302. The one or more servers 302 may include a processor or processors configured to execute one or more software modules 308. Each software module 308 implements all or a part of a functional component of the present invention. For example, one of the software modules 308 may implement all or a portion of methods taught herein for one investor and/or multiple investors. The software modules 308 in some embodiments are integrated with a trade execution system. The software modules 308 in some embodiments are integrated with one or more affiliate modules, such as but not limiting to a portfolio performance tracking system, portfolio data summary report preparation system, marketing brochure preparation system, portfolio credit and risk computing system, legally required periodic reporting system, applicable laws and security exchange compliance system, or combinations thereof. Data, objectives, constraints, constants and investor-specific parameters necessary or useful for implementing the present invention may be stored at one or more databases 310. Also, one or more user machines 304 may be in communication with the server 302 via a network 306. The network 306 may be any kind of suitable wired or wireless network or cloud database and computing resource. User machines 304 may be used, for example, by investors, advisors, portfolio management teams, legal counsels, tax advisors, accounting professionals, risk officers, compliance teams, brokers, any and all affected parties to access the functionality implemented by the server 302. Various embodiments may implement an automated interface to the sever 302, allowing opportunities to be computed and identified, investor preferences and parameters to be revised based on market or non-market developments, alternate scenarios to be created, delayed, time or real time exchange order book data to be displayed, asks and bids to be submitted, information transferred to relevant exchanges and clearing houses, trades to be executed, trade execution confirmation to be received, portfolio contents to be updated, with each passing moment, with or without human intervention. It is to be understood that the figures and descriptions of the present invention have been simplified, to illustrate elements that are relevant for a clear understanding of the present invention, while eliminating, for purposes of clarity, other elements, such as, for example, some specific tasks of maintenance, data backup, security protocols, registration, record filing, custodian tasks, and sendee provider units. Those of ordinary skill in the art will recognize that these and other elements may be desirable, and may be integrated in parts or in full with the present invention. However, because such service elements are well known in the art and because they do not facilitate a better understanding of the present invention, a discussion of such elements is not provided herein.

Various modules and components of the system 300 may be implemented as software code to be executed by a processors) of any computer system using any type of suitable computer instruction type. The software code may be stored as a series of instructions or commands on a computer readable medium. The term “computer-readable medium” as used herein may include, for example, magnetic and optical and solid state memory devices such as diskettes, flash discs, thumb drives, compact discs of both read-only and writeable varieties, optical disk drives, and hard disk drives. A computer-readable medium may also include memory storage that can be physical, virtual, permanent, temporary, volatile, non-volatile, semi-permanent and/or semi-temporary.

### The Methods

Prior art teaches portfolio risk as a function of the volatility of assets that comprise the portfolio. The volatility of the portfolio is derived and expressed in number of ways using terms such as variance, covariance, standard deviation, and such components. This concept and relationship between risk and volatility is taught, for example, by Pillai (U.S. Pat. No. 7,502,756, such as at Col. 1: Lines 20-50, Col. 5); by Gorbatovsky (US Patent Application Pub. No. US 2010/0017338 A1, such as in paragraphs 0008, 0045, 0064 through 0075); by Michaud et al. (U.S. Pat. No. 7,624,060, such as at Col. 1: Lines 22-67, Col. 7: Lines 5-45, Col. 10: Lines 27-36)—each of these is included herein by reference. Additional theoretical considerations of volatility as a measure of risk are discussed in the background section, the prior art cited there, and the references contained within the prior art cited in the background, each of which is included herein by reference in its entirety.

One of several differences between prior art and the present invention is in how risk is defined and considered in creating and managing a portfolio.

Volatility isn't risk. Risk is the likelihood of permanent impairment of capital invested in an asset. An asset that offers no value for any human being, that produces nothing of value to serve the needs of any human being, that consumes more resources from the society than the value it produces for the society is a decaying and destructive asset. Any such decaying and destructive asset will, sooner or later, cause permanent impairment of capital. Any such decaying and destructive asset is risky, and its market volatility is irrelevant as a measure of its risk to an investor.

In contrast to a decaying and destructive asset, is the productive and empowering asset. An asset that offers value to another human being acting independently out of his or her own free will and in pursuit of happiness, an asset that produces something of value to serve the needs of another human being, an asset that consumes less resources from the society than the value it produces for the society is a productive and empowering asset. Any such productive and empowering asset will, sooner or later, produce wealth. The daily market volatility of such productive and empowering assets is irrelevant as a measure of risk to an investor.

For productive and empowering assets, volatility is an opportunity. It can be an opportunity to buy a productive asset at a discount to the value it represents to one investor with certain outlook or needs. It can be an opportunity to sell a productive asset at a premium to the value it represents to another investor with different outlook or needs.

To quantify and specifically teach the method embodiments of the present invention, specific methods are presented, followed by detailed mathematical representation of investor objectives, constraints, constants and parameters. Various symbols are used, each of which are explained after the detailed mathematical representation, along with methods of their determination in various embodiments. Thereafter, specific methods are taught for solving these detailed, mathematical equations.

### Limitations of the Present Invention

The present invention is limited to methods comprising of at least one objective function and at least one constraint. In other words, the following are outside the scope and intent of the present invention:
1. Methods to create and manage investment portfolios comprising of one objective functions but no constraints.
2. Methods to create and manage investment portfolios comprising of no objective functions but one constraint.

### Embodiments of the Methods

The method embodiments of the present invention comprise of at least one objective function and at least one constraint. Some methods comprise of two to four types of constraints. Some methods comprise of five to ten types of constraints. Some methods comprise of eleven to hundred types of constraints. Some methods comprise of more than hundred types of constraints.

Some method embodiments of the present invention comprise of very large number of individual constraints. For some methods this number is greater than the mathematical product of number of assets available and of interest to the investor and number of types of constraints.

The objective functions and constraints of taught methods may comprise of forms such as but not limiting to linear, quadratic, quartic, polynomial, non-linear, integer, real, fractional, differential, integrative, continuous, discrete, negative, positive, independent, dependent, time variant, predictive, adaptive, ex post, ex ante, statistical, algorithmic, heuristic.

In at least one embodiment of the present invention, one the following objective functions is maximized:
1. Present value of future earnings of assets in the investor portfolio.
2. Present value of future dividends received from assets in the investor portfolio.
3. Total return on the investor portfolio.

In at least one embodiment of the present invention, at least one of the following capital availability constraints is satisfied:
1. The total capital available to create or rebalance or re-optimize the portfolio is equal to or less than the sum of cash available to the investor, cash borrowed by the investor, cash investor receives from dividends and other distributions from the assets owned, interest and expenses and transaction costs to be paid by the investor, cash the investor must withdraw from the portfolio to pay taxes or other personal expenses, and the value of current investor portfolio.
2. The total capital available to create or rebalance or re-optimize the portfolio is equal to or less than the sum of new cash investor wants to contribute to the portfolio, cash investor receives from dividends and other distributions from the assets owned, interest and expenses and transaction costs to be paid, by the investor, and the value of current investor portfolio.
3. The ratio of cash borrowed by the investor to total capital available to create or rebalance or re-optimize the portfolio is equal to or less than an investor specific parameter. This capital allocation constraint is a limit on leverage, and it allows the investor to comply with a bound on the leverage as required by lender, applicable leverage regulations, or one desired or deployed by the investor out of prudence.

In at least one embodiment of the present invention, at least one of the following volatility constraints is satisfied:
1. The portfolio volatility is equal to or greater than an investor specified parameter.
2. The portfolio volatility is equal to or greater than an investor specified first parameter, and is also equal to or less than an investor specified second parameter.
3. The portfolio comprises of two or more distinct sets of assets. From these sets of assets, at least one set has asset set volatility equal to or greater than an investor specified first parameter, while for the remaining sets of assets the asset set volatility is constrained to one of the following:

3.1 equal to or less than an investor specified parameter, or

3.2 equal to or greater than an investor specified parameter, or

3.3 equal to or greater than the portfolio volatility over just completed time period, or

3.4 equal to or less than the portfolio volatility over just completed time period, or

3.5 no limitation
4. The portfolio volatility is equal to or greater than a dynamic value calculated using a function of market data or economic variables or both.

In at least one embodiment of present invention, the volatility constraint comprises of greater than or equal to inequality.

The investor specified parameters in 3.1 and 3.2 is same for all sets of asset in some embodiments, and different in other embodiments. The portfolio volatility includes the effect of correlation between the assets, in at least one embodiment, for sake of accuracy or any other reason. In other embodiments, correlation is ignored, for sake of convenience or computational efficiency or information uncertainty or any other reason. The portfolio volatility is derived in some embodiments as weighted average, in other embodiments as volumetric average, in yet other embodiments as geometric average, and other such measures.

The portfolio volatility, or asset set volatility above, is computed over any length of time appropriate or desired by the investor, such as but not limiting to days, weeks, months, quarters, or years. It is important that the method, the period and calculation basis used is consistent across all assets.

The portfolio volatility, or asset set volatility above is computed from historical data, or predicted by a model. Various embodiments deploy different prediction model, such as but not limiting to random walk, moving average, arithmetic average, geometric average, exponential smoothing, exponentially weighted moving average, smooth transition exponential smoothing, regression, autoregressive threshold method, autoregressive conditional heteroskedasticity (ARCH) models, generalized ARCH (GARCH) and its various variants, stochastic volatility models, implied models and the like.

In at least one embodiment of the present invention, at least one of the following investor style constraints is satisfied:
1. Investor is long on all assets the investor owns, and the investor is not short on any assets. In other words, investor's ownership in all assets available or of interest is greater than or equal to zero.
2. Investor is long on some assets, and is short on some assets. Being long numerically implies investor owns a positive number of shares or positive fraction of asset; being short numerically implies investor owns a negative number of shares or negative fraction of asset. In other words, investor's portfolio allocation value in some assets available or of interest is bounded to be greater than or equal to zero; investor's ownership in some other assets available or of interest has no such bounds.
3. Investor is long on some assets, and is short on some assets; however, the investor sets certain maximum limit on portfolio value shorted. In other words, investor's ownership in assets available or of interest is bounded to be greater than or equal to a negative number, that certain maximum limit on portfolio value shorted—an investor specific parameter. Additionally, in this embodiment, the sum of squares of investor's portfolio allocation value in each assets is bounded to be less than or equal to the sum of squares of total capital available for the investor and that certain maximum limit on portfolio value shorted specified by the investor.

In at least one embodiment of the present invention, at least one of the following asset correlation constraints is satisfied:
1. The effective correlation between the assets in the portfolio is equal to or less than an investor specified constant.
2. The effective correlation between the assets in the portfolio is equal to or less than an investor specified first constant, and is also equal to or greater than an investor specified second constant.
3. The effective correlation between the assets in the portfolio in real time is equal to or less than the correlation between other portfolios or between two market indices in real time.
4. The effective correlation of the portfolio at time t is equal to or less than the effective correlation of the portfolio at time t−1.
5. The effective correlation of the portfolio is equal to or less than a dynamic value calculated using a function of market data or economic variables or both.

The effective correlation between the assets in the portfolio is calculated as a function of the fraction of each asset in the portfolio and the correlation between each pair of assets. In some embodiments, this effective correlation computation additionally includes the variance of returns for each asset over time. The calculation of correlation between each pair of assets may be on ex post, or ex ante basis. Any factor methods or predictive models may be employed. The computational method may include any length of time appropriate or desired by the investor, such as but not limiting to days, weeks, months, quarters, or years. It is important that in some embodiments of the method, the period and calculation basis used is consistent across all assets.

The correlation between each pair of assets above is computed as Pearson correlation coefficient, or as Spearman's correlation coefficient, or as rescaied covariance, or as geometric mean of regression slopes, or as Galton ratio of means, or other formulations for correlation coefficients. If investor has no preference, and any method, is considered appropriate, Pearson method for correlation coefficient calculation is used, the basis being asset's return, over a rolling 52 week time period. In another embodiment, the basis being asset's market price, over a rolling 65 day time period. It is important that the correlation calculation method, the calculation period and calculation basis used is consistent across all assets.

In at least one embodiment of the present invention, at least one of the following asset discount constraint is satisfied:
1. The discount of the assets in the portfolio is equal to or greater than an investor specified, constant.
2. The market value of the assets in the portfolio is equal to or less than the mathematical product of an investor specified constant and the net asset value of the assets in the portfolio.
3. The discount of the assets in the portfolio is equal to or greater than the mathematical product of an investor specified constant and the average historical discount of the assets in the portfolio over an investor specified period.
4. The discount of the assets in the portfolio as calculated with real time market data is equal to or greater than the mathematical product of an investor specified constant and the average discount of another portfolio or of a market index in real time.
5. The current discount of each asset in the portfolio is equal to or greater than an investor specified discount parameter for that asset. This constraint may alternatively be expressed as: the current premium for each asset in the portfolio is equal to or less than an investor specified premium parameter for that asset.
6. The weighted discount of the portfolio is equal to or greater than the higher of zero and current weighted, discount of the portfolio.
7. The weighted discount of the portfolio is equal to or greater than a dynamic value calculated using a function of market data or economic variables or both.

The discount of the assets in the portfolio is calculated by first calculating the difference between the current net asset value of the portfolio and the current market value of the assets, and then this calculated, difference is divided by the current net asset value. The investor specified constant for discount constraint may be a number greater than 0.0, or less than 0.0, or equal to 0.0. The calculation of discount or premium may be on ex post, or ex ante basis.

The discount constraint is an effective method to enable an investor to identify wealth creating assets that are available in the market on sale and an attractive margin of safety.

The calculation of average discount may be over any length of time appropriate or desired by the investor, such as but not limiting to days, weeks, months, quarters, or years. It is important that the method, the length of time and calculation basis used is consistent across all assets.

In at least one embodiment of the present invention, at least one of the following information ratio (IR) constraint is satisfied:
1. The information ratio of one or more assets in the portfolio is equal to or greater than an investor specified IR constant.
2. The information ratio of the portfolio is equal to or greater than an investor specified IR constant.
3. The portfolio comprises of two or more distinct sets of assets, each belonging to a separate asset class. Each such set of assets in the portfolio is constrained to:

3.1 an information ratio equal to or greater than an investor specified parameter, or

3.2 an information ratio equal to or greater than the average information ratio of the asset class, or

3.3 an information ratio equal to or greater than the median information ratio of the asset class, or

3.4 an information ratio equal to or greater than its current information ratio, or

3.5 no limitation
4. The information ratio of the portfolio is equal to or greater than a dynamic value calculated using a function of market data or economic variables or both.

The information ratio is a surprisingly useful tool to measure the relative track record and skills of portfolio managers, when the asset is a fond. The information ratio constraint enables embodiments of the present invention that mathematically include the management skill, the breadth of portfolio management team's activity and information coefficient implied in their practice.

The information ratio may be computed on market return basis, or asset earnings basis, or asset dividend distribution basis, or total return basis. The calculation approach may be arithmetic performance or geometric performance. The benchmark used to calculate information ratio is any target benchmark, or risk free security benchmark, or an asset class index with, investment style and focus similar to asset set being compared, or any other. If investor has no preference, and any method is considered appropriate, an asset class index with investment style and focus similar to asset set being compared, is used as the benchmark, the basis being asset's quarterly total return, over rolling 40 calendar quarters, with calculation approach using geometric average return and geometric standard deviation.

The investor specified IR constant for information ratio constraint may be a number greater than 0.14159265, or less than 0.14159265, or equal to 0.14159265. In some embodiments, the investor specified IR constant is 0.28318530. In some embodiments, the investor specified IR constant is 0.56637061, In some embodiments, the investor specified IR constant is 1.13274123. The calculation of information ratio may be over any length of time appropriate or desired by the investor, such as but not limiting to days, weeks, months, quarters, years, or decades. It is important that in some embodiments of the method, the length of time and calculation basis used is consistent across all assets.

In at least one embodiment of the present invention, at least one of the following diversification constraints is satisfied:
1. The fraction of total portfolio value held in one or more asset is equal to or less than an investor specified, constant.
2. The fraction of total portfolio value held in one or more asset is equal to or greater than an investor specified constant.
3. The assets available and of interest to the investor are grouped into asset class categories. The combined, fraction of total portfolio value held in the assets of one or more asset class categories is equal to or less than an investor specified constant.
4. The assets available and of interest to the investor are grouped into asset class categories. The combined fraction of total portfolio value held in the assets of one or more asset class categories is equal to or greater than an investor specified constant.
5. The assets available and of interest to the investor are grouped by the asset's jurisdiction. The combined fraction of total portfolio value held in the assets subject to certain jurisdictions is each constrained to be equal to or less than investor specified constants.

The assets available and of interest to the investor are grouped by the asset's jurisdiction. The combined fraction of total portfolio value held in the assets subject to certain jurisdictions is each constrained to be equal to or greater than an investor specified constants.
7. The assets available and of interest to the investor are grouped by the asset's sponsor. This constraint embodiment is particularly useful when the asset is a fund, such as but not limiting to a mutual fund or closed end fund or hedge fund or exchange traded fund. The combined fraction of total portfolio value held in the assets grouped, by sponsors is each constrained, to be equal to or less than investor specified constants.
8. The assets available and of interest to the investor are grouped by the asset's sponsor, as explained above. The combined fraction of total portfolio value held in the assets grouped by sponsors is each constrained to be equal to or greater than investor specified constants.
9. The combined fraction of total portfolio value held in the assets grouped by sponsors or by jurisdiction or by asset class category is constrained to be equal to or less than a dynamic value calculated using a function of market data or economic variables or both.

Diversification is a useful tool to investors with limited information or limited time for thorough due diligence. Concentration, the reverse of diversification, is a useful tool to investors with in-depth knowledge and understanding and who can continue thorough due diligence of assets available and of interest. Thus in diversification constraints above, a wide range of embodiments are specifically explained.

The asset class categories are grouped in a manner specific and useful to each investor. Each of these categories comprise of assets with similar characteristics, have a market return correlation greater than 0.8 with each other over a period of interest to the investor, and the assets are subject to same laws and regulations. In other embodiments, the market correlation between assets within an asset class category may be a number higher than 0.8, or lower than 0.8 to meet investor specific needs. Some non-limiting illustrations of asset class categories include large capitalization stocks, small capitalization stocks, investment grade corporate bonds, junk bonds, government bonds, municipal bonds, treasury bills, REITs, convertibles, international stocks, international bonds, emerging market stocks, emerging market corporate bonds, emerging market sovereign bonds, precious metals, commodities, energy, oil, biotech/health care, finance, auto, retail, infrastructure.

The investor specified constant for diversification constraint may be a number greater than 0.025, or less than 0.025, or equal to 0.025. In some embodiments, this investor specified constant is 0.05. In some embodiments, this investor specified constant is 0.15. In some embodiments, this investor specified constant is 0.25. In some embodiments, the diversification constraint may be expressed by first developing a mathematical function that measures portfolio diversification or diversification return, and then this mathematical function is bounded to an investor specified constant or a dynamic value calculated using a function of market data or economic variables or both,

In at least one embodiment of the present invention, at least one of the following fundamental performance constraints is satisfied:
1. The earnings yield of each asset in the portfolio is equal to or greater than an investor specified constant for the asset.
2. The earnings yield of each asset in the portfolio is equal to or greater than an investor specified multiple of dividend yield for the asset. In other embodiments, the payout ratio of each asset in the portfolio is constrained to be equal to or greater than an investor specified constant for the asset, or equal to or greater than a multiple of twelve month rolling payout ratio, or equal to or greater than a multiple of average payout ratio for similar assets from its asset class category.
3. The weighted average earnings yield of the portfolio is equal to or greater than an investor specified constant.
4. The weighted average earnings yield of the portfolio is equal to or greater than an investor specified multiple of average dividend yield from the portfolio.
5. The weighted average earnings yield of the portfolio is equal to or greater than the earnings yield of an index.
6. The weighted average earnings yield of the portfolio is equal to or greater than a dynamic value calculated using a function of market data or economic variables or both.
7. The undistributed net investment income per fungible unit of each asset in the portfolio is equal to or greater than an investor specified constant for the asset.
8. The undistributed net investment income per fungible unit of each asset in the portfolio is equal to or greater than an investor specified multiple of the difference between earnings yield and dividend yield for the asset.
9. The realized and unrealized capital gain per fungible unit of each asset in the portfolio is equal to or greater than an investor specified constant for the asset.
10. The weighted average realized and unrealized capital gain per fungible unit of the portfolio is equal to or greater than an investor specified constant.
11. The ratio of debt and preferred shares to common equity for each asset in the portfolio is equal to or less than an investor specified constant for the asset.
12. The PEG ratio, that is the price/earnings to real growth ratio, of each asset in the portfolio is equal to or less than an investor specified constant for the asset. Alternatively, the modified PEG ratio, that is the ratio comprising of price/earnings divided by earnings growth rate plus dividend yield.
13. The Current ratio of each asset in the portfolio is equal to or less than an investor specified constant for the asset.
14. The Quick ratio of each asset in the portfolio is equal to or less than an investor specified constant for the asset.
15. The Cash ratio of each asset in the portfolio is equal to or less than an investor specified constant for the asset.
16. The interest coverage for each asset in the portfolio is equal to or less than an investor specified constant for the asset.

Fundamental performance constraints are a useful measure to investors. While some constraints are illustrated above, similar constraints on other fundamental performance measures are useful in other embodiments. To illustrate but not limit, other such fundamental performance measures include price to book ratio, price to sales ratio, price to cash ratio, free cash flow to equity ratio, return on assets, gross margin per share, net margin per share, percentage insider ownership, return on equity, sales growth over investor specified period, revenue per employee, profit per employee, excess return per share, ratio of revenue from products launched, within last 5 years to total revenue. In other embodiments, two or more of fundamental performance measures are combined into a new measure and then constraints of the like discussed above included in the present invention.

In at least one embodiment of the present invention, at least one of the following miscellaneous constraints is satisfied:
1. The average daily liquidity of one or more assets in the portfolio is equal to or greater than an investor specified parameter for each respective asset or a function of market data.
2. The expense ratio of one or more assets in the portfolio is equal to or greater than an investor specified parameter for each respective asset or a function of market data.
3. The duration of one or more assets in the portfolio is equal to or greater than relevant investor specified parameter for each respective asset or a function of market data.
4. The average maturity of one or more assets in the portfolio is equal to or greater than relevant investor specified parameter for each respective asset or a function of market data.
5. The credit quality or credit rating of one or more assets in the portfolio is equal to or greater than relevant investor specified parameter for each respective asset or a function of market data. Alternatively, the default probability of one or more assets in the portfolio is equal to or less than respective investor specified parameter.
6. The market capitalization of one or more assets in the portfolio is equal to or greater than relevant investor specified parameter for each respective asset or a function of market data.
7. The market capitalization of one or more assets in the portfolio is equal to or less than relevant investor specified parameter for each respective asset or a function of market data.
8. The distribution frequency of one or more assets in the portfolio is equal to or greater than relevant investor specified parameter for each respective asset.
9. The Z statistic of one or more assets in the portfolio is equal to or greater than relevant investor specified parameter for each respective asset.

10. The Z statistic of one or more assets in the portfolio is equal to or less than relevant investor specified parameter for each respective asset.
11. The Sharpe Ratio of one or more assets in the portfolio is equal to or less than relevant investor specified parameter for each respective asset or a function of market data. In some embodiments, the Sharpe Ratio of one or more assets in the portfolio is equal to or greater than relevant investor specified parameter for each respective asset or a function of market data.
12. The Sortino Ratio of one or more assets in the portfolio is equal to or less than relevant investor specified parameter for each respective asset or a function of market data. In some embodiments, the Sortino Ratio of one or more assets in the portfolio is equal to or greater than relevant investor specified parameter for each respective asset or a function of market data.
13. The Value at Risk of one or more assets in the portfolio is equal to or less than relevant investor specified parameter for each respective asset or a function of market data. In some embodiments, the Value at Risk of one or more assets in the portfolio is equal to or greater than relevant investor specified parameter for each respective asset or a function of market data.
14. The Martin Ratio of one or more assets in the portfolio is equal to or less than relevant investor specified parameter for each respective asset or a function of market data. In some embodiments, the Martin Ratio of one or more assets in the portfolio is equal to or greater than relevant investor specified parameter for each respective asset or a function of market data.
15. The Stutzer index of one or more assets in the portfolio is equal to or less than relevant investor specified parameter for each respective asset or a function of market data. In some embodiments, the Stutzer index of one or more assets in the portfolio is equal to or greater than relevant investor specified parameter for each respective asset or a function of market data.
16. The Anns index, or TRIN, for the securities exchange on which an asset is registered, for one or more assets in the portfolio, is equal to or less than relevant investor specified parameter for each respective asset. In some embodiments, the Arms index is equal to or greater than relevant investor specified parameter.
17. One or more sentiment indices with high correlation to one or more assets in the portfolio, is equal to or less than relevant investor specified parameter for each respective asset. In some embodiments, one or more sentiment indices is equal to or greater than relevant investor specified parameter. To illustrate, but not limit, these sentiment indices include short interest, put/call ratio, confidence index, consumer price index, moving averages, various behavior finance indices.

In at least one embodiment of the present invention, the asset price used in the objective function and constraints of the present invention are adjusted to include all transaction-related costs, fees, taxes and charges. In case investor sells, the adjusted price would be the market price minus the transaction costs. In case investor buys, the adjusted price would be the market price plus the transaction costs.

### Objective Functions

Let Pₘ represent the portfolio value at moment m, Pₘ₊ₙ represent the portfolio value at moment m+n, and ξ(Pₘ₊ₙ) represent the expected earnings of portfolio between moment m and future moment m+n. In one embodiment of present invention, the ξ(Pₘ₊ₙ) is maximized, when ξ(Pₘ₊ₙ) is expressed as:

$${\sum }_{i = 1}^{A} {e}_{i} {n}_{i} ( {\prod }_{j = 1}^{J} ( 1 - {t}_{ij} ) ) \qquad ( 3 )$$

Wherein, eᵢ=yᵢPᵢ (4)

Variables such as eᵢ and others are defined and described after some additional embodiments of objective functions have been presented,

In another embodiment, the objective function as expressed in equation (3) is expanded. In these embodiments, the earnings from the portfolio are maximized over all future periods in perpetuity, and wherein the effect of inflation and time value is incorporated into a discount interest rate r. The investor's objective function in equation (3) is extended, to include all future periods, that is the short term and the long term, and is expressed as:

$${\sum }_{n = 1}^{∞} \frac{1}{r} {( 1 - \frac{1}{{( 1 + r )}^{n}} ) [ {\sum }_{i = 1}^{A} {e}_{i} {n}_{i} ( {\prod }_{j = 1}^{J} ( 1 - {t}_{ij} ) ) ]}_{n} \qquad ( 5 )$$

In another embodiment of the present invention, the term expressed in equation (5) is simplified, with the insight that for certain assets such as but not limiting to certain bonds with fixed coupons, the expected earnings are constant for all future periods n. Assets available and of interest to the investor can then be grouped into two groups, one with constant earnings ξ(Pₘ₊ₙ) for all future periods, and another group with varying earnings in future periods. Let Assets 1 through A_{c} represent the former, and A_{c} through A represent the later. Equation (5) may then be simplified and expressed as:

$$\frac{1}{r} [ {\sum }_{i = 1}^{Ac} {e}_{i} {n}_{i} ( {\prod }_{j = 1}^{J} ( 1 - {t}_{ij} ) ) ] + {\sum }_{n = 1}^{∞} \frac{1}{r} {( 1 - \frac{1}{{( 1 + r )}^{n}} ) [ {\sum }_{i = 1}^{A} {e}_{i} {n}_{i} ( {\prod }_{j = 1}^{J} ( 1 - {t}_{ij} ) ) ]}_{n} \qquad ( 6 )$$

It is to be noted that, equation (6) can be further grouped and simplified, such as to the computationally and functionally equivalent objective function equation (3) under certain embodiments of the present invention. For example, when the only available assets to the investor, or only assets of interest to the investor are those with constant earnings ξ(Pₘ₊ₙ) for all future periods, then A equals A_{c}, and only the first term of equation (6) remains. In such embodiments, equation (6) reduces to equation (3) for a constant discount rate r. As another non-limiting illustration, equation (6) may be simplified to the computationally and functionally equivalent objective function equation (3), for some or ail assets, whenever earnings beyond the current or first period are unpredictable or uncertain.

In another embodiment of the present invention, the terms expressed in equation (5) and (6) are simplified, inspired by the admission that infinite time period is a very long time, a summation over infinite time period is indeterminate, and while being mathematically interesting, summation over infinite time periods is nevertheless irrelevant to investors with finite life or finite span of interest. In at least one embodiment, the summation is limited to L, the period of specific interest to the investor: to illustrate but not to limit, L may be the set to expected age of investor and investor's beneficiaries minus the current age of the investor; L may alternatively be set to the expected period from the time investor starts saving to when investor expects his children to incur college expenses; L may alternatively be set to be the remaining life of the fund in case a fund is the investor and fund has a set termination date such as is the case with certain finite-life term trust funds; L may alternatively be set to a computationally convenient number over which investor believes earnings are predictable and of interest, illustrations of such computationally convenient number include but do not limit to 1000 days, 6 months, 12 months, 60 months, 100 weeks, 2000 weeks, 100 months, 500 months, 40 quarters, 20 years, 100 years. In some embodiments, an investor may prefer longer time periods. Illustrations of such investors being philanthropists and endowment funds that aim to fund socially empowering and sustainable charitable causes over many generations; in such embodiments, L may be set to a much larger number. It should be noted that earnings in very distant future are not only uncertain; their present values are very small. With L thus defined as investor specific parameter, Equation (6) is expressed for such embodiments as:

$$\frac{1}{r} [ {\sum }_{i = 1}^{Ac} {e}_{i} {n}_{i} ( {\prod }_{j = 1}^{J} ( 1 - {t}_{ij} ) ) ] + {\sum }_{n = 1}^{L} \frac{1}{r} {( 1 - \frac{1}{{( 1 + r )}^{n}} ) [ {\sum }_{i = 1}^{A} {e}_{i} {n}_{i} ( {\prod }_{j = 1}^{J} ( 1 - {t}_{ij} ) ) ]}_{n} \qquad ( 7 )$$

Equation (5), (6) and (7) are useful in numerous applications. These equations can be further tailored to make them more useful to specific needs of individual investors, and to investors that are funds. As an illustration, these equations can be modified by sophisticated investors to consider assets whose earnings and dividend distributions they expect to grow because of reasons such as the growth in customer base, revenues, productivity, income, capital base, cost of capital, profitability, retained earnings, and knowledge. For such growing assets, the term eᵢ in those equations is substituted, with an earnings model that provides eᵢ, the earning per share for asset i, as a function of asset-relevant factors, such as but not limiting to a company's customer base, revenues, productivity, income, capital base, cost of capital, profitability and retained earnings. One specific illustration of such earnings and dividend, growth model is to be found the teachings of Gordon model (Gordon M. J., “Dividends, Earnings, and Stock Prices”, The Review of Economics and Statistics, 41-2:99-105, May 1959; Gordon's teachings are herewith incorporated herein in full, in particular Gordon's equations (2), (4), (5), (7) and Table 3, as explained in the cited Gordon paper, along with the context and discussion surrounding those equations). For the present invention, one embodiment of Gordon's teachings can be modified into an earnings model, and e. be expressed as

eᵢ=e₀φ₁(ē−e₀) (8)

eᵢ=e₀+φ₁(ē−e₀+φ₂( d̅−d₀) (9)

eᵢ=e₀+φ₁(ē−e₀)+φ₂( d̅−d₀+φ₃( b̅−b₀)+φ₄(e,ovs a−a₀) (10)

Equations (8), (9) and (10) are linear regression models, and the coefficients φᵢ and constants e₀, d₀, b₀ and a₀ therein are defined, methods for their computation explained in the Gordon article cited above. In some embodiments non-linear regression models may be used to project and compute eᵢ over time. In other embodiments, the investor deploys his understanding of suppliers and raw material costs, process steps, value added at and productivity of each process step, utility costs, other fixed and variable costs, finishing, efficiencies of scale, inventory costs, cost of capital, cost of labor, shipping and sales expenses through operations optimization, and such in depth understanding and factors into an dynamic earnings model; this dynamic earnings model then comprises eᵢ, and thus computed e. is utilized in the investor's objective function explained by the present invention through equations such as equation (7).

In yet other embodiments, the earning model for computing eᵢ is derived from identifying assets serving a similar customer base, with similar product, produced using similar starting materials, operating under similar legal regulations. Then the average of current and near term earnings of such an asset class is used to estimate or refine the projected earnings eᵢ of the asset of interest. This embodiment is useful in cases such as but not limiting to mergers and acquisitions where the productivity principles and knowledge of each party can be compared and implemented in the surviving company after the merger and acquisition with competent management.

In equation (4), yᵢ is the yield per share of asset i, nᵢ is the number of shares of asset i in the portfolio of the investor, tᵢⱼ is the inefficiency factor for asset i and the investor from jurisdiction j, symbol Σ represents a sum for each asset i over all assets A that are available to or of interest to the investor, symbol π represents a product for each jurisdiction j over all jurisdictions J that are applicable to the asset and the investor.

In embodiments wherein the portfolio comprises of bonds or notes or any asset that contractually promises to pay a periodic income such as a coupon, the yield yᵢ is computed as the yield to maturity, or as current yield, or as 30 day U.S. Security Exchange Commission (SEC) yield, or as 7 day SEC yield. In some embodiments, the definition utilized for the yield yᵢ is consistent across all assets paying such periodic payments, so as to enable fair evaluation of the competing assets.

In embodiments wherein the portfolio comprises of assets that pay a periodic dividend, the yield yᵢ is the distribution yield, or computed as 30 day SEC yield, or computed as 7 day SEC yield. In various embodiments, the definition utilized for the yield yᵢ is consistent across all assets paying such periodic dividends, so as to enable fair evaluation of the competing assets.

In embodiments wherein the portfolio comprises of stocks or assets that do not pay dividends, the yield yᵢ is computed as the earnings per share divided, by market value per share. The earnings per share is preferably calculated, in accordance with generally accepted accounting principles (GAAPS), compliant with regulations in effect, include the effects of any off balance sheet items and derivatives. In one or more embodiments, the definitions and regulations complied for the earnings per share calculation is consistent across all such assets, even if the assets are from countries with regulations and accounting principles different than those in the United States, so as to enable fair evaluation of the competing assets.

In embodiments wherein the portfolio comprises of futures or options or new ventures or assets that do not report earnings, the yield yᵢ is computed, as the roil yield. In other embodiments, the investor assigns an expected future distributable earnings generated by the asset, and computes the yield yᵢ as arbitrage yield equivalent to this future stream of earnings, after accounting for expenses and expected dilution of investor's share in the ownership of the asset. In yet other embodiments, particularly useful when the asset comprises of precious metals or works of art or historic artifacts or anthropological objects or objects with substantial emotional value, the investor assigns an expected future value of the asset, and computes the yield yᵢ as implied rate of return in the asset's value after accounting for any insurance, security, storage, maintenance and such periodic expenses.

In embodiments wherein the portfolio comprises of assets that report earnings as well as distribute dividends, either or a combination may be used. However, it is preferred that the method of calculation be consistent across the assets, so as to enable fair evaluation of the competing assets. In certain embodiments, such as but not limiting to situations where the dividend distribution comprises in part of return of capital, it is preferred that the actual earnings of the asset are used as a definition of yᵢ, rather than the distribution yield.

In embodiments wherein the portfolio comprises of funds or assets that are by themselves a portfolio of underlying assets, it is preferred that the lesser of (a) distribution yield, and (b) earnings reported by such assets, is used as yield yᵢ in equation (3). If the earnings are not discardable or available, it is preferred, that the investor identify the underlying holdings, and compute the actual composite earnings from the earnings of each individual asset and expenses of each individual liability of the fund. It is preferred that the method of calculations be consistent across the assets, so as to enable fair evaluation of the competing assets.

The term nᵢ in equation (3), for fungible assets, may be a positive or negative number, and it may be a whole or fractional number. When nᵢ is positive, it represents that the investor is long on the asset. When nᵢ is negative, it represents that the investor is short on the asset. For non-fungible assets, the term yᵢnᵢ is preferred to represent the fraction of asset's earning between moment m and moment m+n that is lawfully assignable to the investor at moment m+n in equation (3).

The term tᵢⱼ in equation (3), which is the economic inefficiency factor for asset i and the investor from jurisdiction j, is computed from the judicial, economic policies and tax policies of the country or jurisdiction with legal influence on the asset and the investor. Each factor that affects the earnings lawfully and ultimately received by the investor is considered a different jurisdiction; each such factor is a different tᵢⱼ.

In one embodiment, the jurisdictions are ranked in an order of increasing economic policy instability, and tᵢⱼ is proportionally mapped and set to a value between 0 and +1. To illustrate and not limit, the tᵢⱼ will be close to zero for countries of Type AAAA with a track record of predictable and transparent political environment, independent and transparent legal system, developed and transparent business infrastructure, freedom to work at will and full labor flexibility on wage and numerical and functional basis, sophisticated, financial system regulation with established capital markets, and a track record of market driven currency exchange with unrestricted cash inflows and cash outflows from its jurisdiction. To illustrate and not limit, the tᵢⱼ will be higher for countries of Type BBBB, than countries of Type AAAA, if the country exhibits track record of predictable and transparent political environment, independent and transparent legal system, developed and transparent business infrastructure, freedom to work at will and full labor flexibility on wage and numerical and functional basis, but has limited financial system regulation, and a track record of market driven currency exchange with unrestricted cash inflows and cash outflows from its jurisdiction. To further illustrate and not limit, the tᵢⱼ will be higher for countries of Type CCCC, than countries of Type BBBB, if the country exhibits a track record, of developing and stabilizing political environment, developing and stabilizing legal system, developing but transparent business infrastructure, restrictions on employers in labor or management decisions and limited labor flexibility, limited financial system and capital markets, and controlled currency exchange with unrestricted cash inflows and cash outflows from its jurisdiction. To further illustrate and not limit, the tᵢⱼ will be higher for countries of Type DDDD, than countries of Type CCCC, if the country exhibits a track record of dictatorial and opaque political environment, lack of free press, lack of access to and competitive reporting of facts, opaque legal system, developed and transparent business infrastructure, restrictions on employers in labor or management decisions and limited labor flexibility, limited financial system and capital markets, corrupt and opaque regulation, and controlled currency exchange with unrestricted cash inflows and cash outflows from its jurisdiction. To further illustrate and not limit, the tᵢⱼ will be higher for countries of Type EEEE, than countries of Type DDDD, if the country exhibits a track record of dictatorial and opaque political environment, repetitive and violent change in government, lack of free press, lack of access to and competitive reporting of facts, opaque legal system, limited or nonexistent business infrastructure, restrictions on employers in labor or management decisions and nonexistent labor flexibility, nonexistent financial system, corrupt and opaque regulation, undeveloped or nonexistent capital markets, ad hoc currency exchange policies with arbitrarily restricted cash inflows and cash outflows from its jurisdiction.

TABLE 1

| Jurisdiction Type | tᵢⱼ range |
|---|---|
| AAAA | 0 to 0.05 |
| BBBB | 0.05 to 0.15 |
| CCCC | 0.15 to 0.35 |
| DDDD | 0.35 to 0.65 |
| EEEE | 0.65 to 1.0 |

Table 1 presents illustrative values of tᵢⱼ applicable to assets from various jurisdictions. These values are illustrative, and not meant to limit alternate guidelines. The values applied may be different, classifications may be expanded into categories that fail between Type AAAA and Type BBBB, Type BBBB and Type CCCC, and so on. Additional Types may be created and then jurisdictions evaluated accordingly. A scoring method, with or without weights to each factor, is applied in other embodiments of the present invention. It is preferred that the method of computing tᵢⱼ be consistent across the assets and jurisdictions for an investor, so as to enable fair evaluation of the competing assets and jurisdictions. To simplify the calculations, the economic inefficiency factor tᵢⱼ for Type AAAA jurisdiction may be assigned a value of 0.0.

The term tᵢⱼ will normally be a fraction between −1 and +1. However, in some embodiments, tᵢⱼ may be a number outside of this range. When tᵢⱼ is positive, it represents that the investor pays part of the returns from the asset to the jurisdiction or a third party insuring the jurisdiction. When tᵢⱼ is negative, it represents that the investor receives additional retains from the asset from the jurisdiction—perhaps as a refund—or the investor receives additional returns from a third party seeking to encourage investments into the jurisdiction.

In other embodiments of the present invention, the term tᵢⱼ is a number resulting from the regulatory and tax laws of the jurisdictions applicable to the asset and the investor. Each independently applicable fee, tax or any other charges payable—by the asset before the investor can lawfully receive his share of earnings or by the investor after he lawfully receives his share of the earnings from the asset—to third parties for owning the asset, is treated as a separate economic inefficiency factor tᵢⱼ. To illustrate, but not limit, if an investor must pay 18% income tax to cantonal and municipal jurisdiction, and an additional 0.3% total net worth tax on the incremental asset, then there are two separate tᵢⱼ applicable to the asset i and the investor, namely tᵢ₁=0.18, and tᵢ₂=0.003. As another illustration, but not to limit the scope of the present invention, if an investor must pay 40% general income tax to one jurisdiction, an additional 12.1% social income tax to a second jurisdiction, and an additional 1.65% property/solidarity (L'impot de solidarite sur la fortune) tax under a third jurisdiction, then there are three separate tᵢⱼ applicable on the asset i and the investor, namely tᵢ₁0.4, tᵢ₂=0.121, and tᵢ₃=0.0165. As yet another illustration, but not to limit the scope of the present invention, if an investor must pay 1.1 % currency conversion fee to one jurisdiction, an additional 9.3% alternative minimum tax to a second jurisdiction, an additional 8.746% insurance and transaction charge to a third jurisdiction, and incur a further 3.2% expense to comply with securities exchange rules and other legal requirements, then there are four separate tᵢⱼ applicable on the asset i and the investor, namely tᵢ₁=0.011, tᵢ₂=0.093, tᵢ₃=0.08746, and tᵢ₄=0.032.

In other embodiments of the present invention, the investor identifies and includes ail applicable tᵢⱼ for each asset, prior to investing in the asset; these economic inefficiency factors tᵢⱼ include any and all fees and charges and taxes and expenses and payments that the investor must make to and under jurisdiction j at any time to lawfully and prudently purchase, own and sell the asset i.

For sake of clarity, jurisdictions need not be limited to governments, the term includes any and all lawful entities or third parties entitled to such payments because of applicable laws or lawfully executed contract implied in the asset or entered by the investor.

### Constraints

In at least one embodiment of the present invention, the method for creating and managing a portfolio comprises of capital availability constraint. This constraint limits the portfolio value to be less than or equal to the total capital available to invest. In one embodiment, the capital availability limit is expressed as the following constraint

$${\sum }_{i = 1}^{A} {n}_{i} {P}_{i} \leq {P}_{m} + {C}_{I , m} - {C}_{W , m} \qquad ( 11 )$$

Wherein Pᵢ is the market price per unit of asset i, nᵢ is the number of units of asset i in more optimal portfolio, Pₘ is the value of the currently less optimal portfolio at moment m, C_{I,m} is the additional cash the investor seeks to invest at moment m, C_{W,m} is the cash the investor seeks to withdraw from the portfolio at moment m. Investor may seek to withdraw cash for personal reasons such as to pay taxes or pay for expenses or pay periodic interest on leverage and margin or meet fund redemption requirements or to distribute to stakeholders and charity or the like. Investor may seek to add cash C_{I,m} from sources such as but not limiting to monthly income, savings, inheritance, periodic bonus, tax refund, successful sale of another asset, fund subscription, closing of rights offer, merger, settlements such as those of options and future contracts, leverage capital from line of credit or sale of preference shares or margin, or the like.

In one embodiment of the present invention, the investor is interested, in portfolios that comprises only of long positions, and has no interest in portfolios that comprise of short positions. For such an investor, the following investor style constraint is used:

nᵢ≧0 (12)

In another embodiment of the present invention, the investor is interested in portfolios that comprise of long and short positions, however, the investor seeks to limit the amount of capital deployed in short position in asset i to be equal to or less than a maximum value v_{short,i}. For such an investor, the following constraint is used:

nᵢPᵢ≧−v_{short,i} (13 )

In another embodiment of the present invention, the investor is interested in portfolios that comprise of long and short positions, however, the investor seeks to limit the combined, total amount of capital deployed in all short positions to be equal to or less than a maximum value v_{short,max}. For such an investor, there are several alternate expressions that may be used. One of the more elegant and beautifully simple form is:

nᵢPᵢ≧−v_{short,max} (14 )

In another embodiment of the present invention, the investor is interested in portfolios that comprise of leverage. Such an investor, for example, may be a fund that leverages its asset base to increase its managed assets by issuing secondary securities such as term preferred loans or preferred shares or variable demand notes. Such an investor may be legally required, to, or may out of prudence desire to limit the amount of leverage Lₘ deployed at moment m to an amount less than a certain percentage φ of the total portfolio value. Another non-limiting illustration of such an investor is an individual who borrows funds through a loan and is contractually or legally required to, or may out of prudence desire to limit the amount of leverage Lₘ deployed at moment m to an amount less than a certain percentage φ of the total portfolio value. For such investors, the following constraint is used:

Lₘ≦ØPₘ (15)

In at least one embodiment of the present invention, the method for creating and managing a portfolio comprises of volatility constraint. This constraint limits the portfolio volatility to be greater than or equal to an investor specific parameter. The prior art teaches portfolio volatility is risk, and that everything else being same an investor is better served with a portfolio that exhibits lower volatility than one that exhibits higher volatility.

The present invention considers risk as the likelihood of permanent impairment of real value of capital; volatility, at best, is a measure of uncertainty, and that portfolio volatility can be an opportunity. Everything else being same, in contrast to prior art, the present invention teaches that an investor is better served with a portfolio that exhibits higher volatility than one that exhibits lower volatility. A portfolio with higher volatility enables an investor to buy the asset when its market price falls to levels where the asset is an attractive bargain compared to other assets, and to sell the asset when its market price rises to levels where other assets become an attractive bargain compared to the asset currently owned by the investor.

In one embodiment, the volatility constraint is expressed as the following:

$${\sum }_{i} {n}_{i} {P}_{i} ( {\sum }_{n = 1}^{N} {( ln \frac{{P}_{n}}{{P}_{n - 1}} - \overline{R} )}^{2} ) \geq {V}_{min} \qquad ( 16 )$$

### Wherein,

$$\overline{R} = \frac{1}{N} {\sum }_{i = 1}^{N} ln \frac{{P}_{i}}{{P}_{i - 1}} \qquad ( 17 )$$

This embodiment is particularly useful when the asset's market price movement is randomly independent and identically distributed, asset returns can be continuously compounded, and when the asset prices Pᵢ at moment i has been adjusted for dividends paid by the asset. Equation (16) is useful even in those circumstances where some or all of these assumptions are not valid.

In another embodiment, the volatility of returns for all assets is calculated, over a period of interest to the investor, and stored as a vector V(r). Let X be the vector comprising of fraction of each asset in the portfolio, and X^{T} be the transpose of X. The volatility constraint is expressed, in matrix notation, as one or both the following constraints:

X^{T}V(r)≧V_{min,port} (18)

X^{T}V(r)≦V_{max,port} (19)

Another embodiment of the volatility constraint includes the covariances between the asset pairs. As in equation (18) and (19), for this embodiment, the variances σᵢᵢ and covariances σᵢⱼ of returns for all assets is calculated, over a period of interest to the investor, and stored as a matrix S(r). The volatility constraint is expressed, in matrix notation, as the following constraint:

X^{T}S(r)X≧V_{min,port} (20)

The Vₘᵢₙ in equation (17), V_{min,port} and V_{max,port} in equation (18) through (20) are each an investor specified parameter. These parameters may be a constant, independent of market data, economic factors or time. Alternatively, the investor may vary one or more of these parameters over time to suit his or her particular needs and uncertainty appetite. In some embodiments, the investor may set this parameter to be a function of market data, economic factors, another index, and one or more of such variables.

In another embodiment, the volatility vector V(r) or variance-covariance matrix S(r) or both are determined from excess returns over a benchmark or a naively selected portfolio. In at least one embodiment, the volatility for ail assets is calculated, on ex post basis, over a period of interest to the investor, and stored as a vector V(r). In at least another embodiment, the volatility for all assets is calculated, on ex ante basis, over a period of interest to the investor, and stored as a vector V(r). X^{T} is computed by mathematical, evolutionary, heuristic or other optimization methods, such as described later.

In yet another embodiment, the investor classifies assets for the portfolio into asset class categories. Each asset class may be grouped, in a manner specific and useful to each investor, and these asset classes may differ from one investor to another. These categories, to illustrate without limiting, comprise of assets with similar characteristics, have a market return con-elation greater than 0.7 with each other over a period of interest to the investor, have similar systemic and non-systemic risk of permanent loss of shareholder capital, and the assets' method of creating products, service and thereby wealth for society are subject to similar laws and regulations. In other embodiments, the market correlation between assets within an asset class category may be a number higher than 0.7, or lower than 0.7 to meet investor specific needs. Some non-limiting illustrations of asset class categories include government bonds, municipal bonds, treasury bills, REITs, convertibles, investment grade corporate bonds, junk bonds, international stocks, international bonds, emerging market stocks, emerging market corporate bonds, emerging market sovereign bonds, precious metals, commodities, grains, meat and agricultural products, energy, oil, utilities, natural gas pipelines, mining and resource exploration, biotech/health care, finance, auto, airlines, retail, shipping and transport, infrastructure, and others. Each such asset class may be further sub-classified, to meet the needs of a fund, needs such as investor's diversification or concentration. Illustrations of such sub-classification include, without limiting the scope of the present invention, for energy asset group: wind energy, solar energy, hydroelectric energy, geothermal energy, nuclear energy, waste to energy, ocean energy, agriculture fuel based energy, bio energy, and so on. Another example of asset sub-classification is large capitalization asset, mid cap, small cap. Yet another illustration of asset sub-classification is geographic or economic development of the market where the asset is operating to create or provide products, service and thereby wealth for society. These asset classifications are useful, to some investors, in formulating various types of constraints.

For volatility constraints, the asset classifications are used in some embodiments, for some investors. The asset class based volatility constraint is expressed, as one or both the following constraints:

|X^{T}V(r)|ⱼ≧V_{min,asset class j}j=1, 2, . . . asset classes (21)

|X^{T}V(r)|ⱼ ≦V_{max,asset class j} j=1, 2, . . . asset classes (22)

In another embodiment, the volatility constraint is expressed, as a function of continuously changing market variables, Ωᵥ. Illustration of such market variables Ωᵥ include, but do not limit to: VIX, the market volatility index calculated and disseminated, in real time by Chicago Board Options Exchange; VXD, the Dow Jones Volatility Index; VXN, the NASDAQ Volatility Index; RVX, the Russell 2000 Volatility Index, VXO, the Standard & Poors (S&P) 100 Volatility Index; SML, S&P Small Cap 600 Index; PUT, the CBOE S&P 500 PutWrite Option Index; OVX, the Crude Oil Volatility Index; GVZ, the Gold Volatility Index; VXXLE, the Energy Sector Volatility Index; VXEEM, the Emerging Markets Volatility Index; MOVE, the Merrill Lynch Bond Volatility Index; Markit VoiX, the European and North American credit derivatives market volatility index; Markit MCDX, the United States municipal credit index; Markit LCDX, the North American first lien leveraged loan credit default swap index; COAL, the Stowe Global Coal Index; DJUBS, the Dow Jones-UBS Commodity Index; DBLCI, the Deutsche Bank Liquid Commodity Index; CSCB, the Credit Suisse Commodity Benchmark Index; DBCC, Deutsche Bank NASDAQ OMX Clean Tech Index; XAL, American Stock Exchange Airline Index; RLX, S&P Retail Index; S&P/Case-Shiller home price index; consumer price index; 12 month moving average of inflation data; exponential moving average of volatility difference between indices; z-statistic score of implied discount of a fund; and others.

Alternatively, a time dependent function is used to express the bounds of volatility constraint, wherein the changing volatility of another asset is used, or the function comprises of correlation or performance or fundamentals of another asset, or another portfolio, or an index. For example, as one or more of the following constraints:

$$\begin{matrix}{X}^{T} V ( r ) \geq a + b {Ω}_{v} , \\ where \\ 0 \leq b \leq 1 & ( 23 ) \\ {X}^{T} V ( r ) \geq a + {max}_{0 \leq b \leq 1} b {e}^{- {b}^{2}} ( {Ω}_{v} ) & ( 24 ) \\ {X}^{T} V ( r ) \leq {Ω}_{v} & ( 25 )\end{matrix}$$

The a and b in equation (23) through (25) are each an investor specified constant. The constant b is less than 1, in some embodiments. With a combination of these constraints, Ωᵥ as VIX index, and constants a=0 and b=0.5 as examples, the investor can specify that she desires a portfolio that has volatility higher than 0.5 times the current market volatility as expressed by VIX index, and a portfolio volatility that is less than the current market volatility as expressed by VIX index. Equations (23) through (25) are non-limiting examples. Simpler or more complex equations, such as those based on factor models, regression analysis, cause-effect methods are useful.

In all these and equations before, the time period used affects the volatility values and V(r). A time period, that is appropriate for one investor may not be appropriate for another investor. In one embodiment, the time period used is related to the investment horizon and goals of the investor, as well time available to the investor to manage the portfolio, and its turnover. In another embodiment, multiple volatility constraints with different time periods are simultaneously used. In another embodiment, shorter time periods are useful when the yield, curve is inverted or flat, and longer time periods are useful when the yield curve is steep.

In at least one embodiment, the volatility values and investor specific parameters in equations (16) through (25) are forecasted. Let the forecasted value for any variable q be represented by \tilde{q}. Then, for illustration without limiting the scope of the present invention, some alternate forecasting methods for volatility at time t, are:

$$\begin{matrix}Random Walk \text{:} \\ {\tilde{V} ( r )}_{t} = {V ( r )}_{t - 1} & ( 26 ) \\ Moving Average \text{:} \\ {\tilde{V} ( r )}_{t} = \frac{1}{τ} {\sum }_{i = 1}^{τ} {V ( r )}_{t - i} & ( 27 ) \\ Historical Average \text{:} \\ {\tilde{V} ( r )}_{t} = \frac{1}{t - 1} {\sum }_{i = 1}^{t - 1} {V ( r )}_{t - i} & ( 28 ) \\ Exponentially Weighted Moving Average \text{:} \\ {\tilde{V} ( r )}_{t} = \frac{1}{{\sum }_{i = 1}^{τ} {β}^{i}} {\sum }_{i = 1}^{τ} {β}^{i} {V ( r )}_{t - i} & ( 29 )\end{matrix}$$

In equations (26) through (29), βⁱ are the weights and τ is the time period of interest. Autoregressive and stochastic methods are useful in certain embodiments of the present invention. Equation (30) illustrates such autoregressive methods. The variables in equation (30) correspond to those known in the art. Other variants of GARCH, such as the family GARCH omnibus model, may be used as well.

$$Generalized Autoregressive conditional heteroskedasticity ( GARCH ) \text{:} \\ {\tilde{V} ( r )}_{t} = \sqrt{[ {∝}_{0} + {\sum }_{i = 1}^{n} {∝}_{i} {( {E ( r )}_{t - i} )}^{2} + {\sum }_{i = 1}^{m} {{β}_{i} ( {V ( r )}_{t - i} )}^{2} ]} \qquad ( 30 )$$

In at least one embodiment, the correlation constraint is expressed as one or more of the following:

[Σⱼ₌₁^{A}Σᵢ₌ⱼ^{A}nᵢPᵢρᵢⱼ]−Σᵢ₌₁^{A}nᵢPᵢ≦ρ_{P,max} (31)

Σⱼ₌₁^{A}Σᵢ₌ⱼ^{A}xᵢρᵢⱼ≦1+\acute{ρ}_{P,max} (32)

[Σⱼ₌₁^{A}Σᵢ₌ⱼ^{A}nᵢPᵢρᵢⱼ]−Σᵢ₌₁^{A}nᵢPᵢ≧ρ_{P,min} (33)

Σⱼ₌ₐ^{A}Σᵢ₌ⱼ^{A}aᵢρᵢⱼ≧1+\acute{ρ}_{P,min} (34)

In equation (31) and (32), Xᵢ is the fraction of portfolio value in asset i, A is the number of Assets available and of interest to the investor, Pᵢ is the market price per unit of asset i, and nᵢ is the number of units of asset i in more optimal portfolio. The parameters ρ_{p,max}, ρ_{p,min}, \acute{ρ}_{p,max} and \acute{ρ}_{p,min} are investor specific parameters.

In another embodiment of the correlation constraint, first the correlation of returns, ρᵢⱼ, between each pair of all assets is calculated, over a period of interest to the investor, and stored as a matrix ρ(r).

$${ρ}_{ij} = \frac{{\sum }_{t = 1}^{τ} [ {( {r}_{i} - {\overline{r}}_{i} )}_{t} {( {r}_{j} - {\overline{r}}_{j} )}_{t} ]}{\sqrt{{\sum }_{t = 1}^{τ} {( {r}_{i} - {\overline{r}}_{i} )}_{t}^{2}} \sqrt{{\sum }_{t = 1}^{τ} {( {r}_{j} - {\overline{r}}_{j} )}_{t}^{2}}} \qquad ( 35 )$$

In equation (35), t represents time such as daily or weekly or hourly or any other suitable period, rᵢ and rⱼ are returns of asset i and j respectively at time t, and r̅ᵢ and r̅ⱼ are average returns of asset i and j respectively over the total period of time τ. Let X be the vector comprising of fraction of each asset in the portfolio, and X^{T} be the transpose of X. The correlation constraint is expressed, in matrix notation, as either or both of the following constraints:

X^{T}ρ(r)X−X^{T}X≦ρ_{p,max} (36)

X^{T}ρ(r)X−X^{T}X≧ρ_{p,min} (37)

The investor specific parameters for correlation constraints may be a constant, independent of market data, economic factors or time. Alternatively, the investor may vary one or more of these parameters over time to suit his or her particular needs. In some embodiments, the investor may set this parameter to be a function of market data, economic factors, another index, and one or more of such variables.

In another embodiment, the vector ρ(r) is determined from excess returns of each asset over risk free asset, or a benchmark or a naively selected portfolio.

In at least one embodiment, the asset discount constraint is included in formulating the portfolio creation and management method. In some embodiments, it is expressed as one or more of the following:

Σᵢ₌₁^{A}xᵢDᵢ≦D_{P,max} (38)

Σᵢ₌ₐ^{A}xᵢDᵢ≧D_{P,min} (39)

In equation (38) and (39), xᵢ is the fraction of portfolio value in asset i, A is the number of Assets available and of interest to the investor, and Dᵢ is the discount for asset i in more optimal portfolio. The parameters D_{p,max} and D_{p,min} are investor specific parameters for asset discount. The discount of asset i is computed by first calculating the difference between net asset value and market price, then this result is dividend by the net asset value of the asset. For many exchange traded securities, mutual funds, closed end funds, and other assets the net asset value is reported by the security exchanges. In some embodiments, the intrinsic value of the asset is substituted for the net asset value. In yet other embodiments, a capital asset pricing model is used to estimate the efficient market equilibrium price of the asset and this equilibrium price is used in place of net asset value.

In at least one embodiment, an information ratio constraint is included in formulating the portfolio creation and management method. Information ratio constraint enables an investor to measure performance and track record of management who actively manage the asset, and to prefer managers who have proven, over time, a consistent skill in creating wrealth. Information ratio constraint also enables an investor to avoid assets with managers who sometimes report unexpectedly high performance not because of skill, but because of luck. The premise here is that skilled managers tend to learn, innovate, produce flawless products, serve compelling needs of society ever more efficiently, and produce better results from consequent knowledge and hard work. Success then is habit, a consequence of relentless sincerity of purpose and application of the best within a team. Identifying such teams creating wealth through excellence is a valuable screening criterion for an investor. Information Ratio, and its variants, offer such a tool in the form of constraints.

For some embodiments, the information ratio constraint is expressed as one or more of the following, for some or ail of the assets available to and of interest to the investor:

$$\begin{matrix}( \frac{1}{τ} {\sum }_{t = 1}^{τ} {[ {R}_{i} - {R}_{b} ]}_{t} ) ( \frac{1}{\sqrt{( \frac{1}{τ} {\sum }_{t = 1}^{τ} {[ {R}_{i} - {R}_{b} ]}_{t}^{2} )}} ) \geq {IR}_{i , min} & ( 40 ) \\ ( \frac{1}{τ} {\sum }_{t = 1}^{τ} {[ {R}_{i} - {R}_{b} ]}_{t} ) ( \frac{1}{\sqrt{( \frac{1}{τ} {\sum }_{t = 1}^{τ} {[ {R}_{i} - {R}_{b} ]}_{t}^{2} )}} ) \geq {a}_{i} + {b}_{i} f ( ϕ ) & ( 41 )\end{matrix}$$

In equation (40) and (41), Rᵢ is the return from asset i, R_{b} is the return on a benchmark b, (Rᵢ−R_{b})ₜ is the active management excess return from asset i and benchmark b over the period t, τ is maximum number of performance periods of interest to the investor, IRₘᵢₙ is an investor specific parameter representing the minimum information ratio acceptable to the investor, a and b are investor specific constants and f(φ) represents a function of market variables and fundamentals that in combination with a and b provide a dynamic target value for the minimum information ratio acceptable to the investor,

The Rᵢ and R_{b} may be calculated by any method that provides a meaningful measure of performance to the investor. Three illustrations follow:

$$\begin{matrix}{R}_{i} = ln \frac{{P}_{i , t}}{{P}_{i , t - 1}} & ( 42 ) \\ {R}_{i} = \frac{{P}_{i , t} - {P}_{i , t - 1}}{{P}_{i , t - 1}} & ( 43 ) \\ {R}_{i} = \frac{{P}_{i , t} - {P}_{i , t - 1} + {D}_{t , t - 1}}{{P}_{i , t - 1}} & ( 44 )\end{matrix}$$

Equation (42) represents the continuously compounded return, equation (43) represents the arithmetic return, equation (44) represents the total return as it includes any dividends and distributions paid by the asset, D_{t,t-1}, between time t−1 and t. In addition to returns expressed in equations (42) through (44), geometric returns, harmonic returns and generalized, power returns are useful.

In other embodiments, the return may include any key performance indicator important to the investor. If is important that the definition be objectively applied to both the assets in consideration and the benchmark.

The benchmark may simply be an asset that the investor considers risk free. In alternate embodiments the benchmark may simply be the performance of her capital if she chose to do nothing. In other embodiments, the benchmark b is another asset or an index that is similar in potential and risk to the asset i. In yet other embodiments, multiple benchmarks b are used, for each asset in order to create and manage investor's portfolio from available assets. In other embodiments, the performance of asset over benchmark b is split into timing-based and selection-based performance, and each of these constraint equations then included.

The time interval t and total time period T may be any appropriate period. In some embodiments, the time interval is days, in others weeks or months or quarters or years or two years or five years or decades, or the like. In some embodiments, the total time period is 10, in others 25 or 52 or 96 or 1000 or 5000 or 10000 or 65536, or the like.

In at least one embodiment, the benchmark is an exchange traded fund or a portfolio of exchange traded securities.

Equation (40) through (44) represent one version of information ratio, wherein the denominator quantifies the excess active uncertainty inherent in asset i over benchmark b. Alternate expressions for information ratio are useful in some embodiments of the present invention.

Other alternate forms of information ratio comprise of a numerator that measures the active return by asset i over benchmark b, and a denominator that measures the active risk represented, by asset i over benchmark b. To illustrate, without limitation, the active risk is represented in some embodiments as the excess non-performance risk of asset i, Nᵢ, over the non-performance risk of benchmark b, N_{b}over period, of interest. With this modification, the information ratio constraint is expressed, in at least one embodiment of the present invention, as:

$$\begin{matrix}( \frac{1}{τ} {\sum }_{t = 1}^{τ} {[ {R}_{i} - {R}_{b} ]}_{t} ) ( \frac{1}{1 + \sqrt{( \frac{1}{τ} {\sum }_{t = 1}^{τ} {[ {N}_{i} - {N}_{b} ]}_{t}^{2} )}} ) \geq {IR}_{i , min} & ( 45 ) \\ ( \frac{1}{τ} {\sum }_{t = 1}^{τ} {[ {R}_{i} - {R}_{b} ]}_{t} ) ( \frac{1}{1 + \sqrt{( \frac{1}{τ} {\sum }_{t = 1}^{τ} {[ {N}_{i} - {N}_{b} ]}_{t}^{2} )}} ) \geq {a}_{i} + {b}_{i} f ( ϕ ) & ( 46 )\end{matrix}$$

For an asset such as a bond, or loan, the non-performance risk may be the default risk of the bond or loan. A suitable benchmark for assets that are bonds or loans, in some embodiments, is the risk free bond which has non-performance risk of zero. Another suitable benchmark for a bond or loan, in some embodiments, is a benchmark bond index acceptable to the investor; such as, Barclays Capital Aggregate Bond Index, Salomon BIG Index, Salomon Smith Barney World Government Bond Index, J.P. Morgan Emerging Markets Bond. Index, Merrill Lynch High Yield. Master Index, S&P Leveraged Loan Index, Asset-backed Securities Index.

The non-performance risk measure as formulated in equations (45) and (46) is motivated by the premise that managers of assets must observe, screen, choose and thereby take risk. A management team that plays if safe by simply acquiring the benchmark asset does reduce their excess non-performance risk to zero, but it also reduces their excess returns over benchmark to zero. The non-performance risk measure should encourage managers to strive for higher return for equivalent risk, or strive for lower risk for equivalent return.

The non-performance risk is easier to measure with bonds and loans. The concept, nevertheless, applies to stocks and all other forms of asset. Any asset that fails to create wealth and thereby earn competitive income yield, is on a path to non-performance and default. Therefore, even for other types of asset an equivalent non-performance measure, one based on income yield generated on shareholder capital in exchange for innovation, operational and other risks undertaken, is useful. There too it should encourage managers to strive for higher return for equivalent risk, or strive for lower risk for equivalent return.

Other effective expressions for information ratio are based on power means, that is generalized, forms of Pythagorean means namely geometric, harmonic and arithmetic means. For example, information ratio constraints in the present invention may be expressed in one of the following geometric forms:

$$\begin{matrix}{( {\prod }_{t = 1}^{τ} {[ {{R}^{′}}_{i} - {{R}^{′}}_{b} ]}_{t} )}^{\frac{1}{τ}} ( \frac{1}{1 + exp ( \sqrt{( \frac{1}{τ} {\sum }_{t = 1}^{τ} {[ ln \frac{{[ {{R}^{′}}_{i} - {{R}^{′}}_{b} ]}_{t}}{{( {\prod }_{t = 1}^{τ} {[ {{R}^{′}}_{i} - {{R}^{′}}_{b} ]}_{t} )}^{\frac{1}{τ}}} ]}_{t}^{2} )} )} ) \geq {IR}_{i , min} & ( 47 ) \\ {( {\prod }_{t = 1}^{τ} {[ {{R}^{′}}_{i} - {{R}^{′}}_{b} ]}_{t} )}^{\frac{1}{τ}} ( \frac{1}{1 + exp ( \sqrt{( \frac{1}{τ} {\sum }_{t = 1}^{τ} {[ ln \frac{{[ {{R}^{′}}_{i} - {{R}^{′}}_{b} ]}_{t}}{{( {\prod }_{t = 1}^{τ} {[ {{R}^{′}}_{i} - {{R}^{′}}_{b} ]}_{t} )}^{\frac{1}{τ}}} ]}_{t}^{2} )} )} ) \geq {a}_{i} + {b}_{i} f ( ϕ ) & ( 48 )\end{matrix}$$

### Where,

$${{R}^{′}}_{i} = \frac{{P}_{i , t}}{{P}_{i , t - 1}} \qquad ( 49 )$$

In at least one embodiment of the present invention, the method for creating and managing a portfolio comprises of diversification constraints. These constraints enable an investor to reduce his risk, over time, from his ignorance, or from lack of time to do detailed due diligence, or from lack of skills and resources to thoroughly research and track the developments in the market place in real time, or from information asymmetry between him, his counterparty in the market and the asset managers. World's financial market have experienced a history, for example, of asset managers who have created wealth through prudence, drive and innovative foresight, and also of asset managers who have destroyed wealth from Ponzi schemes and the like. Such sociological, cognitive and psychological reality is a source of risk: it can cause permanent impairment of investor capital. Diversification offers a means of reducing such risk.

Diversification may be gauged in some embodiments from Pearson correlation coefficient. A portfolio correlation near zero suggests that the parameter of interest to the investor—returns, or price, or default risk—over time is expected to be generally independent of each other. However, this definition of diversification addresses only part of the motivation of diversification, namely investor's self-knowledge that she is uncertain and insufficiently informed about asset classes. As explained, above, sociological, cognitive and psychological reality suggests there are benefits of diversification between assets even when assets are highly correlated. In uncertain times in stable jurisdictions, or stable times in uncertain jurisdictions, diversification reduces the risk of permanent impairment of her investment capital. Diversification amongst highly correlated assets is also useful in situations where the investor is unsure of herself about the nature of time and jurisdiction. Therefore, in some embodiments of the present invention, the investor may diversify within an asset class, across different asset classes; the investor may diversify across assets with different maturities ranging from fixed income assets with short durations or negative durations or long durations, to common stocks with no maturity; the investor may diversify across jurisdictions.

For some embodiments, the diversification constraint is expressed at the portfolio level. Let A be the number of assets available to investor for her diversification needs. Let xᵢ be the fraction of her investment assets allocated to asset i. Then the diversification constraint, and the portfolio diversification index, [symbol] , in some embodiments is expressed as:

[symbol]

≧δ_{portfolio} (50)

where,

$$D = 1 - \frac{{\sum }_{i = 1}^{A} {\sum }_{j = 1}^{A} ( {x}_{i} - {x}_{j} )}{2 ( A - 1 )} \qquad ( 51 )$$

The number of available assets, A, in equation (51) is always a number greater than 1, in some embodiments greater than at least 10, in some embodiments greater than at least 25, in some embodiments greater than at least 40, and in some embodiments greater than at least 100. The diversification index is a number between 0% and 100%, representing 0% diversification and 100% diversification respectively. The δ_{portfolio} is therefore a number within that range, and an investor specified parameter. The δ_{portfolio} may be a constant, or may be changed by the investor over time, or a function of market variables or fundamentals of importance to the investor.

Methods for programming ease and computational efficiency may be employed by re-arranging equations described, or by reformulating the equations herein. These are natural and anticipated extensions of disclosed invention. For example, the constraint expressed by equation (50) may be re-arranged as:

$${\sum }_{i = 1}^{A} {\sum }_{j = 1}^{A} ( {x}_{i} - {x}_{j} ) \leq 2 ( A - 1 ) ( 1 - {δ}_{portfolio} ) \qquad ( 52 )$$

For some embodiments, the diversification constraint is expressed, in an alternate way, as one or more of the following, for some or ail of the assets available to and of interest to the investor:

$$\begin{matrix}\frac{{n}_{i} {P}_{i}}{{\sum }_{i = 1}^{A} {n}_{i} {P}_{i}} \leq {δ}_{i , max} & ( 53 ) \\ \frac{{n}_{i} {P}_{i}}{{\sum }_{i = 1}^{A} {n}_{i} {P}_{i}} \geq {δ}_{i , min} & ( 54 )\end{matrix}$$

The δ_{i,max} and δ_{i,min} are investor specified parameters representing the maximum exposure and minimum exposure, that the investor desires, respectively, in asset i.

In yet other embodiments, the investor classifies assets for the portfolio into asset class categories, as discussed in an earlier section. The diversification constraint is then expressed on asset class level. Let Aⱼ be the number of assets in asset class j. The asset class based volatility constraint is expressed, as one or both the following constraints:

$$\begin{matrix}{\sum }_{k = 1}^{Aj} \frac{{n}_{k} {P}_{k}}{{\sum }_{i = 1}^{A} {n}_{i} {P}_{i}} \leq {δ}_{j , max} j = 1 , 2 , … asset classes & ( 55 ) \\ {\sum }_{k = 1}^{Aj} \frac{{n}_{k} {P}_{k}}{{\sum }_{i = 1}^{A} {n}_{i} {P}_{i}} \geq {δ}_{j , min} j = 1 , 2 , … asset classes & ( 56 )\end{matrix}$$

The δ_{j,max} and δ_{j,min} are investor specified parameters representing the maximum exposure and minimum exposure, that the investor desires, respectively, in asset class j.

In some embodiments, investors may seek concentration rather than diversification. Such concentration is useful to investors in enhancing their returns and reduce their risk, over time, because of his in depth understanding and knowledge, his confidence in his and his team's skills and available resources to thoroughly research and track the developments in the market place in real time, or other appropriate reasons. In these cases, the investor may prefer equation (56) and similar constraints.

In at least one embodiment of the present invention, the method for creating and managing a portfolio comprises of fundamental performance constraints. These constraints enable an investor to create and manage a portfolio comprising assets with certain fundamental performance characteristics. Illustrations of fundamental performance constraints include:

eᵢ≧yᵢ (57 )

In equation (57), eᵢ and yᵢ represent current income earnings per unit and current distribution yield per unit respectively, for asset i.

A wide range of fundamental performance variables may be similarly structured, into constraints. To illustrate, but not limit, fundamental performance variables such as undistributed net investment income, realized and unrealized capital gain, debt ratio, leverage, price to earnings (P/E) ratio, current ratio, P/E to real growth (PEG) ratio, quick ratio, cash ratio, interest coverage ratio, and the like. Let [symbol] ᵢ be any fundamental performance variable for asset i, then a generic representation of fundamental performance constraint is one or both of:

[symbol]

_{i≧∀}_{i,min} (58)

[symbol]

ᵢ≦∀_{i,max} (59)

where ∀_{i,min} and ∀_{i,max} are investor specific parameters for fundamental performance variable.

In some embodiments, a moving average of fundamental performance and other constraint indicators is useful. The moving average may be a simple moving average, or cumulative moving average, or weighted moving average, or exponential moving average, or volume weighted moving average, or the like. In other embodiments, median or other statistical measure is useful in place of average. In yet other embodiments, average may be arithmetic mean, geometric mean, harmonic mean or power mean.

As illustration, some alternate useful formulations of equation (58) are:

$$\begin{matrix}{\sum }_{n = 1}^{N} {F}_{i , n} \geq {\sum }_{n = 1}^{N} {∀}_{i , n} & ( 60 ) \\ {\sum }_{n = 1}^{N} n {F}_{i , n} \geq {\sum }_{n = 1}^{N} n {∀}_{i , n} & ( 61 ) \\ {\sum }_{n = 1}^{N} ( N - n ) {F}_{i , n} \geq {\sum }_{n = 1}^{N} ( N - n ) {∀}_{i , n} & ( 62 ) \\ {\sum }_{n = 1}^{N} {( \frac{N - 1}{N + 1} )}^{n - 1} {F}_{i , n} \geq {\sum }_{n = 1}^{N} {( \frac{N - 1}{N + 1} )}^{n - 1} {∀}_{i , n} & ( 63 )\end{matrix}$$

As further illustrations of moving averages, alternate useful formulations of equation (59) are:

$$\begin{matrix}{\sum }_{n = 1}^{N} {F}_{i , n} \leq {\sum }_{n = 1}^{N} {∀}_{i , n} & ( 64 ) \\ {\sum }_{n = 1}^{N} n {F}_{i , n} \leq {\sum }_{n = 1}^{N} n {∀}_{i , n} & ( 65 ) \\ {\sum }_{n = 1}^{N} ( N - n ) {F}_{i , n} \leq {\sum }_{n = 1}^{N} ( N - n ) {∀}_{i , n} & ( 66 ) \\ {\sum }_{n = 1}^{N} {( \frac{N - 1}{N + 1} )}^{n - 1} {F}_{i , n} \leq {\sum }_{n = 1}^{N} {( \frac{N - 1}{N + 1} )}^{n - 1} {∀}_{i , n} & ( 67 )\end{matrix}$$

In equations (60) through (67), N is the number of periods over which the investor wants to look back to formulate a rolling average fundamental performance constraint. For example, for a 12 month roiling average, N is 12. N may be different for different investors, and between each asset for the same investor. Equation (57) may also be represented in the forms of equation (60) through (67).

The eᵢ, yᵢ, [symbol] ᵢ, ∀_{i,n}, in equations (57) through (67) may be ex post data, or ex ante data. The ∀_{i,n} may be a constant, or may be changed by the investor over time to suit the needs of the investor, or be a function of market variables or fundamentals of importance to the investor.

Equations (57) through (67) are constraint formulations on individual asset basis. In some embodiments, a portfolio-basis or asset class-basis constraint is useful. Let A be ail assets, and Aⱼ be the number of assets in asset class j. Illustrations of these are:

$$\begin{matrix}{\sum }_{j = 1}^{A} \frac{{n}_{j} {P}_{j} {F}_{j}}{{\sum }_{i = 1}^{A} {n}_{i} {P}_{i}} \leq {∀}_{portfolio , max} & ( 68 ) \\ {\sum }_{j = 1}^{A} \frac{{n}_{j} {P}_{j} {F}_{j}}{{\sum }_{i = 1}^{A} {n}_{i} {P}_{i}} \geq {∀}_{portfolio , min} & ( 69 )\end{matrix}$$

The ∀_{portfolio,max} and ∀_{portfolio,min} are vestor specified parameters representing the maximum and minimum bound on portfolio-wide fundamental performance variable, respectively, that the investor desires.

$$\begin{matrix}{\sum }_{k = 1}^{Aj} \frac{{n}_{k} {P}_{k} {F}_{k}}{{\sum }_{i = 1}^{A} {n}_{i} {P}_{i}} \leq {∀}_{j , max} j = 1 , 2 , … asset classes & ( 70 ) \\ {\sum }_{k = 1}^{Aj} \frac{{n}_{k} {P}_{k} {F}_{k}}{{\sum }_{i = 1}^{A} {n}_{i} {P}_{i}} \geq {∀}_{j , min} j = 1 , 2 , … asset classes & ( 71 )\end{matrix}$$

The ∀_{j,max} and ∀_{j,min} are investor specified parameters representing the maximum and minimum bound on portfolio-wide fundamental performance variable, respectively, in asset class j.

In at least one embodiment of the present invention, the method for creating and managing a portfolio comprises of miscellaneous constraints. Illustrations of miscellaneous constraints include:

nᵢ≦Lᵢ (72)

In equation (72), nᵢ and Lᵢ represent number of shares in investor's optimal portfolio and daily traded volume of shares respectively, for asset i. In some embodiments, nᵢ in equation (72) may be replaced with number of fungible units of asset i.

A wide range of miscellaneous variables for assets available and of interest to the investor may be similarly structured into constraints. To illustrate, but not limit, miscellaneous variables such as expense ratio, duration, average maturity, credit score, market capitalization, asset default probability, distribution frequency per year, z statistic score, multifactor aggregate z score, momentum, Sharpe Ratio, Sortino Ratio, Martin Ratio, Ulcer Ratio, Value at Risk, Stutzer Index, Arms Index, Sentiment Index, Market Indices, Moving Average Indices, and the like. Let [symbol] ᵢ be any such miscellaneous variable for asset i, and ∀_{i,min} and ∀_{i,max} be the target bounds, each a investor specific parameter for the miscellaneous variable, then a generic representation of useful miscellaneous constraints are given by equations (58) through (71). One or more of these constraints are included in some embodiments of present method for creating and managing a portfolio.

### Methods for Solving Objective Functions and Constraints

In the section above, various embodiments of objective functions and various embodiments of constraints were described. Together, they form various embodiments of an optimization problem. Each embodiment of optimization problem is a useful formulation of the goals and needs of different investors. As the goals and needs of each investor change, at different times in his or her life, so would the embodiment taught herein to properly formulate the appropriate optimization problem.

The generic representation of this optimization problem is given by:

max_{χ}f(χ) (73)

subject to:

gᵢ(χ)=0, iεE

gᵢ(χ)≧0, 68 I_{GE}

g(χ)≦0, iεI_{LE}

where E, I_{GE} and I_{LE} are the index sets of equality, greater than or equal to inequality, and less than or equal to inequality constraints.

The optimization problem (73) is solved in the present invention, by methods known in the art, depending on the linearity or non-linearity of the formulation. For some investors, the embodiments of objective function and constraints selected will be an optimization problem (73) that is linear, and in these cases linear programming algorithms such as the simplex method and interior point methods suffice. For other investors, optimization problem (73) is non-linear, and non-linear programming algorithms are necessary.

In at least one embodiment, the optimization problem herein is solved with one or more or combinations of the following programming algorithms: simplex programming, interior point programming, linear programming, quadratic programming, conic optimization, integer programming, dynamic programming, stochastic programming, fractional programming, robust optimization, univariate optimization, nonsmooth optimization, semidefinite programming, combinatorial optimization, mixed integer programming, nondifferentiable optimization, constrained optimization, multivariate unconstrained optimization, heuristic-based optimization, metaheuristic algorithms, genetic algorithms, simulated annealing, Tabu search, particle swarm optimization, neural network programming, and the like. These methods are described by prior art such as Cornuejols G. and Tütüncü R., Optimization Methods in Finance, Cambridge UK, Cambridge University Press, 2007; and Hillier F. S. and Lieberman G. J., Introduction to Operations Research, 7^{th} Edition, New York, McGraw Hill, 2001—both of which are herewith included by reference. The present inventions will continue to benefit from anticipated mathematical insights and breakthroughs that improve scope, speed and reliability of optimization methods.

The programming algorithms above may be coded into a software package in any programming language and installed on systems discussed earlier. These may be installed, on systems such as, but not limiting to dedicated, desktops, tablets, mobile phones, as networked intranet resource, as a networked cloud computing resource, as distributed programming resources, or as application software resource such as JAVA®.

In at least one embodiment, the optimization problem herein is solved with one or more open license software or commercially sold software well known in the art, such as, but not limiting to Microsoft® Solver Foundation, IBM® CPLEX ILOG, Oracle® Optimizer, CenterSpace® NMath, GNU linear programming kit, Gurobi®, Mosek®, Axioma®, OptimJ, KNITRO®, CONOPT, GRG2, LOQO, MINOS, SNOPT, SeDuMi, ASCEND, and AMPL.

In at least one embodiment, large scale versions of optimization problem herein are solved, for an investor through a search algorithm. First, the optimization problem is solved for current market data and for select popular combinations of portfolio objectives, constraints and investor specific constants and parameters. The results are stored in a database. Whenever the investor seeks one of the popular combinations, an immediate search result is provided to the investor. With time current market data changes, triggering a change in the pre-calculated optimal results in the solution database. These optimal results can additionally serve as starting point for more complicated requests, or benchmarks to compare alternate solutions for the investor to choose from.

### EXAMPLES

### Example 1

### Creating Portfolios

A retired investor wishes to create a stock portfolio from $200,000. He seeks highest monthly dividend income, with a strong desire for capital preservation. From a pool of numerous assets, he seeks to invest only in stocks. From over 10,000 stocks available to him on US stock exchanges, he is interested in creating a portfolio from a pool of just 10. Table 2 presents the characteristics of these 10 stocks. The investor wants to be fully invested, does not want to borrow and invest, does not want to short (hold negative positions in any of these stocks), and does not want to hold cash. How should the investor create his investment portfolio?

TABLE 2

| | Market | Annual | Default | Earnings | |
|---|---|---|---|---|---|
| | Price | Dividend | Proba- | per | Vola- |
| Stock | per share | Yield | bility | Share/month | tility |
| A | 14.67 | 6.009% | 0.55% | 0.0846 | 2.83% |
| B | 14.60 | 6.040% | 0.33% | 0.0842 | 3.17% |
| C | 14.77 | 5.519% | 0.49% | 0.0807 | 4.77% |
| D | 15.59 | 6.350% | 1.09% | 0.0814 | 4.68% |
| E | 15.85 | 5.657% | 0.26% | 0.0761 | 3.31% |
| F | 14.51 | 6.254% | 1.08% | 0.0545 | 2.37% |
| G | 15.32 | 6.227% | 1.73% | 0.0814 | 3.60% |
| H | 14.69 | 6.277% | 1.45% | 0.0867 | 4.70% |
| I | 15.90 | 6.120% | 0.23% | 0.0803 | 3.40% |
| J | 15.32 | 5.113% | 0.42% | 0.0761 | 4.07% |

A naïve selection would be to invest the entire amount in stock D, as it offers the highest dividend income.

A systematic selection was made as follows: the investor requirements were converted into an optimization problem according to the present invention. The objective function was represented by equation (3) wherein tᵢⱼ was assumed to be zero. The capital availability limit constraint was expressed as equation (11), with C_{I,m} as 200000, Pₘ and C_{W,m} as 0.0. The investor style constraint was expressed with equation (12). The volatility constraint was expressed as equation (18), with V_{min,port} of 3%. The fundamental performance constraint was expressed as equation (57). The asset default probability miscellaneous constraint was expressed as equation (59), with the investor specified parameter for default probability ∀ᵢ bounded to 0.5%.

The optimization problem was solved on a desktop with Intel® Core™ i7 CPU X980 at 3.33 Ghz, 18 GB RAM, 64-bit machine, using express module of Microsoft® Solver Foundation version 3.0. The solution was found in 0.01 seconds.

The optimal solution found for the investor: Invest $136,494 in stock I thereby acquiring 9,292 shares of stock I, and $63,506 in stock D thereby acquiring 4,277 shares of stock D. This answer is different than the naive selection mentioned above. Studying table 1, stock I offers lowest default probability risk and its earnings exceed the dividend it distributes.

### Example 2-4

### Volatility as Opportunity

The example 1 was revisited with volatility constraint modified. Table 3 presents the new investor specified parameters V_{min,port} and solutions for the investor,

TABLE 3

| Example # | V_{min,port} | Solution Found |
|---|---|---|
| 2 | 3.5% | Buy 4277 shares of stock D, and 9292 |
| | | shares of stock I |
| 3 | 4% | Buy 2678 shares of stock C, 3462 |
| | | shares of stock D, and 7422 shares of |
| | | stock I |
| 4 | 4.5% | Buy 9597 shares of stock C, 1358 |
| | | shares of stock D, and 2593 shares of |
| | | stock I |

Example 2 would provide a monthly income of $1032, while Example 4 would provide a monthly income of $953. This is a surprising result because prior art methods teach higher volatility implies higher risk which in turn implies higher returns. However, according to the teachings of the present invention, higher volatility isn't risk rather an opportunity, and greater opportunity may sometimes come with lower immediate returns.

### Example 5-7

### Diversification of a Portfolio

To example 1, a diversification constraint was added, as expressed by equation (53). Table 4 presents three examples each at a different level of investor specified diversification parameter δ_{i,max}. The objective function and other constraints in these examples were same as example 1.

TABLE 4

| | δ_{i.max}, | |
|---|---|---|
| Example # | for all i | Solution Found |
| 5 | 15% | Buy 2045 shares of A, 2054 shares of |
| | | B, 2031 shares of C, 2020 shares of D, |
| | | 1924 shares of E, 222 shares of H, 2042 |
| | | shares of I, and 1044 shares of J. |
| 6 | 25% | Buy 3408 shares of A, 3425 shares of |
| | | B, 2596 shares of D, 734 shares of E, |
| | | and 3404 shares of I. |
| 7 | 35% | Buy 505 shares of A, 4795 shares of B, |
| | | 3541 shares of D, and 4765 shares of I. |

Example 5 would ensure that no more than 15% of an investor's capital is invested in any single security and the solution found by present invention will provide a monthly income of $981 to the investor. Example 7 provides less diversification and a monthly income of $1025 to the investor. Example 6 provides intermediate diversification of the three examples, and a monthly income of $1015 to the investor. In other words, the investor desiring more diversification in her portfolio has to accept lower monthly income. A surprising result is the minor difference in monthly incomes between example 6 and 7, when compared to example 5 and 6.

### Example 8-10

### Asset Classes in a Portfolio

To example 1, asset classes were created for the convenience of the investor, grouping assets A through D as Asset Class 1, E and F as Asset Class 2, and G through J as Asset Class 3. Additionally, a diversification constraint was added as expressed, by equation (55), which limited investor exposure to any one Asset class to be less than equal to δ_{j,max}.

TABLE 5

| | δ_{j,max}, all | |
|---|---|---|
| Example # | asset classes | Solution Found |
| 8 | 35% | Buy 685 shares of B, 4040 shares of |
| | | D, 3849 shares of E, and 4765 shares |
| | | of I |
| 9 | 45% | Buy 2114 shares of B, 3982 shares of |
| | | D, 1283 shares of E, and 6127 shares |
| | | of I |
| 10 | 55% | Buy 2054 shares of B, 4041 shares of |
| | | D, and 7488 shares of I |

These examples confirm that investor requests for asset classes can be readily addressed with the present invention.

### Example 10-12

### Managing a Portfolio

Starting with an already created, portfolio of examples 10-12, the methods taught in the present invention were applied to manage an existing portfolio in light of different set of market prices. The goal was to check whether the present method can provide guidance for an existing portfolio's rebalancing and dynamic adjustments based on quarter to quarter, week to week, or even intraday volatility in market prices. Table 6 presents a new market condition.

TABLE 6

| | Market | Annual | Default | Earnings | |
|---|---|---|---|---|---|
| | Price | Dividend | Proba- | per | Vola- |
| Stock | per share | Yield | bility | Share/month | tility |
| A | 14.92 | 5.9085% | 0.55% | 0.0846 | 2.83% |
| B | 14.33 | 6.1535% | 0.33% | 0.0842 | 3.17% |
| C | 14.12 | 5.7730% | 0.49% | 0.0807 | 4.77% |
| D | 15.21 | 6.1997% | 1.09% | 0.0814 | 4.68% |
| F | 15.01 | 5.8761% | 0.26% | 0.0761 | 3.31% |
| F | 16.44 | 6.0294% | 1.08% | 0.0545 | 2.37% |
| G | 13.98 | 6.4634% | 1.73% | 0.0814 | 3.60% |
| H | 14.33 | 6.7109% | 1.45% | 0.0867 | 4.70% |
| I | 15.12 | 5.9464% | 0.23% | 0.0803 | 3.40% |
| J | 16.99 | 4.7853% | 0.42% | 0.0761 | 4.07% |

Table 7 presents the new solution. The solution to each problem set took less than 0.01 seconds using system and methods discussed earlier.

TABLE 7

| | δ_{j,max}, all | |
|---|---|---|
| Example # | asset classes | Solution Found |
| 11 | 35% | Buy 4885 shares of B, 3997 shares of |
| | | E, 2608 shares of H, and 2221 shares |
| | | of I |
| 12 | 45% | Buy 6281 shares of B, 1332 shares of |
| | | E, 2570 shares of H, and 3619 shares |
| | | of I |
| 13 | 55% | Buy 6281 shares of B, 2609 shares of |
| | | H, and 4943 shares of I |

Portfolio solutions in examples 11-13 for the investor are distinctly different from examples 8-10. They confirm that present inventions offer an effective way for an investor to manage a portfolio with changing market conditions.

### Example 13

### Creating a Portfolio with Short Positions

Starting with an already created portfolio in example 11, the methods taught in the present invention were applied to address an investor's willingness to short one or more of the stocks, subject to two conditions: (a) if such an investment strategy would increase his monthly income, and (b) the amount of the borrowed and shorted stock will not exceed $20,000 per shorted asset and $200,000 in total. It was assumed the investor will be obliged to pay dividends every month to the owner he borrowed the stock from, at a rate equal to the market dividend rate paid by the stock.

This problem was solved, in the manner explained, in example 1 and 11. The solution was found in 0.02 seconds. The investor solution: Short 1283 shares of A, 1378 shares of stock C, 1305 shares of stock D, 1217 shares of F, 1431 shares of G. With $120,000 capital raised by shorting and $200,000 in capital available, buy 8202 shares of stock B, 5330 shares of stock E, 6781 shares of stock H and 849 shares of shares I.

To contrast example 11 and 13, the monthly income was compared. Example 11 portfolio solution pays a net monthly income of $1028, while Example 13 portfolio is a more optimal solution and will pay a net monthly income of $1085—a 5.6% increase in his income over Example 11 portfolio. The two constraints specified by the investor above were met: (a) the shorting strategy increases his monthly income, and (b) the amount of the borrowed and shorted stock, in the optimal portfolio, does not exceed $20,000 per shorted asset and $200,000 in total.

### Example 14

### Portfolio of Bonds

A fund, registered as a regulated investment company in the United States, wishes to create a corporate bond portfolio from $10,000,000. The fund manager's primary objective is to maximize income with capital preservation; her secondary objective is capital appreciation. Let us assume she is restricted to creating a portfolio from a pool of just 10 bond funds. Table 8 presents the characteristics of these 10 bond funds. The fund wants to be fully invested, invest no more than 20% of assets under management in any single bond fund, and does not want to borrow funds for leverage. How should the fund manager create her portfolio?

TABLE 8

| | Market | Annual | Default | | |
|---|---|---|---|---|---|
| | Price | Dividend | Proba- | | Vola- |
| Bond | per share | Yield | bility | Duration | tility |
| B1 | 100.189 | 3.58% | 2.91% | 4.5 years | 3.11% |
| B2 | 100.941 | 1.434% | 1.5% | 2.1 years | 1.47% |
| B3 | 104.877 | 5.297% | 1.5% | 23.4 years | 4.77% |
| B4 | 103.591 | 4.899% | 10.29% | 7.9 years | 8.23% |
| B5 | 103.293 | 6.004% | 29.93% | 6.4 years | 7.88% |
| B6 | 81.375 | 9.216% | 53.72% | 68.3 years | 11.05% |
| B7 | 105.261 | 4.586% | 0.23% | 3.9 years | 2.15% |
| B8 | 101.36 | 7.756% | 0.23% | 6.7 years | 6.99% |
| B9 | 100.983 | 5.953% | 0.23% | 11.3 years | 9.27% |
| B10 | 107.417 | 3.131% | 0.6% | 6.2 years | 3.66% |

The fund manager's requirements were converted into an optimization problem according to the present invention. The objective function was represented by equation (3) wherein the j in tᵢⱼ was assumed to be 1 (United States jurisdiction), and tᵢ₁ as 4% (the excise tax on undistributed income on regulated, investment companies in the United States). The capital availability limit constraint was expressed as equation (11), with C_{I,m} as 10,000,000, Pₘ and C_{W,m} as 0.0. The style constraint was expressed with equation (12). The volatility constraint was expressed as equation (18), with V_{min,port} of 4%. The fundamental performance constraint was expressed as equation (57). The asset default probability miscellaneous constraint was expressed as equation (59), with the investor specified parameter for default probability ∀ᵢ bounded to 1.0%.

The optimization problem was solved on a desktop with Intel® Core™ i7 CPU X980 at 3.33 Ghz, 18 GB DDR3 SDRAM, 64-bit machine operating Windows(r) 7, using express module of Microsoft® Solver Foundation version 3.0. The solution was found in 0.01 seconds.

The optimal solution found for the fund manager: Invest $1,913,420 in bond B1, $2,000,000 each in bond B3, B7, B8 and B9, and $86,580 in bond B10. The portfolio income yield will be 5.43%.

### Example 15

### Fund of Funds, Mutual Funds, Exchange Traded Funds and Closed End Funds

An endowment fund wishes to manage a portfolio worth $20,000,000 comprising entirely of one asset whose exchange ticker symbol is BAB (see Table 9a). The fund manager's primary objective is to maximize income with capital preservation; with secondary objective as capital appreciation. Let us assume the fund is restricted to creating a portfolio from a pool of 3 mutual funds, 3 exchange traded funds, 3 closed end funds, and one fund of funds. Table 9a presents an overview of these 10 funds, while table 9b presents the data for these funds.

The endowment fund wants to be fully invested, invest no more than 25% of assets under management in any single asset, and does not want to use leverage.

TABLE 9a

| Fund | Sponsor | Fund's holdings |
|---|---|---|
| ACG | AllianceBernstein | US Treasuries, Corporate Debt, Agency |
| | LP | Debt, Non-US corporate debt, Securitized |
| | | Loans, Inflation protected securities, |
| | | Preferreds, Derivatives |
| EDD | Morgan Stanley | Emerging Market Corporate Debt, |
| | Investment | Emerging Market Government Debt, |
| | Management Inc. | Derivatives |
| BGT | Blackrock | Communications, Consumer non-cyclical, |
| | | Consumer Cyclical, Capital Goods, Equity, |
| | | Preferreds, Convertibles, Loans |
| PRHYX | T Rowe Price | Corporate Bonds, Convertibles, Preferreds, |
| | | REIT, Futures, Options, Swaps, Forward |
| | | Currency Exchange Contracts |
| JIPAX | John Hancock | Foreign government securities, corporate |
| | | debt, developed market and emerging |
| | | market securities, agency securities, |
| | | currency instruments |
| HYLDX | Invesco | Fixed income securities of telecom, oil & |
| | | gas, construction, banks, insurance, |
| | | airlines, gaming, health care assets |
| AMLP | Alerian | Master Limited Partnerships exchange |
| | | traded fund |
| SCHP | Schwab | United States Treasury Inflation Protected |
| | | Securities exchange traded fund |
| BAB | Invesco | Taxable municipals, Build America Bonds |
| | | exchange traded fund |
| PASAX | PIMCO | A Fund of Funds comprising of funds with |
| | | real return assets, stocks, bonds in |
| | | consumer, energy, financial services, |
| | | technology, healthcare, industrials, real |
| | | estate, and utilities sectors |

The endowment fund wants to be fully invested, invest no more than 25% of assets under management in any single asset, and does not want to use leverage.

TABLE 9b

| | | | Payout | | |
|---|---|---|---|---|---|
| | Market | Annual | Ratio = | Average | |
| | Price | Dividend | Dividends/ | Daily | Vola- |
| Fund | per share | Yield | Earnings | Volume | tility |
| ACG | 7.91 | 6.07% | 1.023 | 669,000 | 3.39% |
| EDD | 17.59 | 6.82% | 0.825 | 219,000 | 3.91% |
| BGT | 15.29 | 6.08% | 0.921 | 83,000 | 3.95% |
| PRHYX | 6.88 | 6.31% | 0.926 | Redeemable | 1.96% |
| JIPAX | 11.25 | 6.43% | 1.087 | Redeemable | 2.10% |
| HYLDX | 17.23 | 6.01% | 0.815 | Redeemable | 1.85% |
| AMLP | 16.15 | 6.09% | 1.054¹ | 795,000 | 2.05% |
| SCHP | 52.79 | 6.31% | 1.0 | 44,000 | 1.63% |
| BAB | 26.4 | 5.56% | 1.018 | 154,100 | 2.56% |
| PASAX | 12.45 | 6.66% | 0.962 | Redeemable | 1.66% |

¹The Payout Ratio for AMLP is calculated as dividend distributions to shareholders by the fund divided by investment income from MLPs to the fund.

The fund manager's requirements were converted, into an. optimization problem according to the present invention. The objective function was represented by equation (3) wherein the tᵢⱼ was assumed to be 0. The capital availability limit constraint was expressed as equation (11), with Pₘ as 20,000,000, C_{I,m} and C_{W,m} as 0.0. The style constraint was expressed, with equation (12) for the funds identified in Table 9a; for the remaining funds equation (12) was modified to be equal to zero (setting 920 ETFs out of 923 bound as zero, 621 out of 624 closed end funds bound to zero, and 963 out of 964 open ended fund of funds (FOF) bounded to zero). While over 7500 mutual funds exist in the United States as of December 2010, this example considered a subset of 1000 non-FOF mutual funds from the 7500 mutual funds, setting 997 of these to be bounded as equal to zero per equation (12). The volatility constraint was expressed as equation (18), with V_{min,port} of 2%. The fundamental performance constraint was expressed as equation (57).

The optimal solution found for the endowment fund in accordance with the present invention: Sell BAB worth $20,000,000. Concurrently invest $5,000,000 each in EDD, SCHP, and PASAX, $4,903,300 in BGT and $96,700 in PRHYX. This portfolio will provide an annual income of 6.47%.

For comparison, the same problem was addressed with efficient frontier (EF) algorithm of the prior art, which treats volatility as risk, rather than opportunity. According to EF algorithm, the EF optimal solution is: Sell BAB worth $20,000,000. Concurrently invest $5,000,000 each in PASAX, PRHYX, and J1PAX, $3,050,000 in AMLP, $850,000 each in EDD and BGT, and $250,000 in SCHP. EF optimal portfolio will provide an annual income of 6.4%,

This example suggests that the EF optimal solution is significantly different than the optimal solution found above in accordance with the present invention. This example also suggests that the present invention can be applied to creating and managing portfolio comprising of a wide range of assets such as the fund holdings listed in Table 9a.

### Uses

The method embodiments of the present invention comprise of formulating an investor's need to create and manage portfolios of assets as an optimization problem comprising of at least one objective function and at least one constraint.

In at least one embodiment of the present invention, the objective functions comprise of maximizing one of the following: current earnings of assets in the portfolio, expected value of future earnings of assets in the portfolio, current dividend, distributions by assets in the portfolio, expected value of future dividend distributions by assets in the portfolio, total return on assets in the portfolio.

In at least one embodiment of the present invention, the constraints comprise of at least one of the following: capital availability constraint, volatility constraint, style constraint, correlation constraint, discount constraint, information ratio constraint, diversification constraint, fundamental performance constraint, and miscellaneous constraint. Another embodiment comprises at least two of these constraints.

The systematic method of allocating capital to wealth generating assets is useful to individual investors, wealth managers, and fund sponsors. They are also useful to organizations entrusted with the goal of allocating capital internally, amongst operating assets that generate wealth with different risks of failure, different performance volatilities and different efficiencies. The methods and systems taught herein are useful in product synthesis and product portfolio creation and management—such as but not limiting to manufacturing centers or supermarkets—wherein the goal is to allocate an organization's internal resources between numerous products each with different wealth generating yields, resource consumption, risks and constraints. The methods and systems taught herein are useful in process synthesis wherein the goal is to allocate an organization's internal venture capital between alternate processes each with different wealth generating yields, resource consumption, risk constraints and natural performance. Examples of such processes include, but do not limit to, processes taught in issued United States patents having a common inventor (U.S. Pat. Nos. 7,914,617, 7,857,244, 7,776,383, 7,708,974, 7,547,431, 6,746,791, 6,713,176, 6,607,821, 6,3875,60, 6,202,471, 5,952,040, 5,851,507).

In useful applications of the present invention, an equivalent objective function is formulated along with equivalent important constraints. These are then solved by the methods taught herein.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention.

Other embodiments of the invention will be apparent to those skilled in the art from a consideration of the specification or practice of the invention disclosed herein. It is intended that the specification and examples be considered as exemplary only, with the true scope and spirit of the invention being indicated, by the following claims.

What is claimed is:

1. A computer-implemented, method for creating and managing a portfolio of assets for an investor comprising:
providing an optimization problem comprising:
at least one objective function; and
at least two constraints selected, from the group consisting of capital availability constraint, volatility constraint, style constraint, correlation constraint, discount constraint, information ratio constraint, diversification constraint, fundamental performance constraint, and miscellaneous constraint;
solving, using a processor, the optimization problem to generate a desired allocation of assets within the portfolio of assets; and
allocating the assets within the portfolio of assets in accordance with the desired allocation of assets.

2. The method of claim 1 wherein the optimization problem includes a volatility constraint with a greater than or equal to inequality.

3. The method of claim 2 wherein the algorithm comprises of a selection from the group consisting of simplex programming, interior point programming, linear programming, quadratic programming, conic optimization, integer programming, dynamic programming, stochastic programming, fractional programming, robust optimization, univariate optimization, non-smooth optimization, semi-definite programming, combinatorial optimization, mixed integer programming, metaheuristic algorithms, genetic algorithms, simulated annealing, Tabu search, particle swarm optimization, neural network programming.

4. The method of claim 2 wherein the portfolio of assets comprises of a selection from the group consisting of mutual fund, closed end fund, exchange traded fund, hedge fund, trust fund, venture capital fund, fund, of funds, money market fund, convertible security, derivative, loan, debenture, certificate of deposit, commodity, future, option, tax exempt security, stock, bond and swap.

5. The method of claim 1 wherein the objective function comprises of earnings per share, number of shares and at least one inefficiency factor.

6. The method of claim 1 wherein the optimization problem comprises of at least two constraints, one of which is volatility constraint comprising of greater and equal to inequality and another selected from the group consisting of capital availability constraint, style constraint, correlation constraint, discount constraint, information ratio constraint, diversification constraint, fundamental performance constraint, and miscellaneous constraint.

7. The method of claim 1 wherein the optimization problem comprises of at least three constraints selected, from the group consisting of capital availability constraint, volatility constraint, style constraint, correlation constraint, discount constraint, information ratio constraint, diversification constraint, fundamental performance constraint, and miscellaneous constraint.

8. The method of claim 1 wherein the optimization problem comprises of at least four constraints selected from the group consisting of capital availability constraint, volatility constraint, style constraint, correlation constraint, discount constraint, information ratio constraint, diversification constraint, fundamental performance constraint, and miscellaneous constraint.

9. The method of claim 1 wherein the optimization problem comprises of at least five or more constraints selected from the group consisting of capital availability constraint, volatility constraint, style constraint, correlation constraint, discount constraint, information ratio constraint, diversification constraint, fundamental performance constraint, and miscellaneous constraint.

10. The method of claim 1 wherein the optimization problem comprises of fundamental performance constraint comprising fundamental performance variables selected from the group consisting of current income earnings, current distribution yield, undistributed net investment income, realized and unrealized capital gain, debt ratio, leverage, P/E ratio, current ratio, PEG ratio, quick ratio, cash ratio, and interest coverage ratio.

11. The method of claim 1 wherein the optimization problem comprises of miscellaneous constraint comprising miscellaneous variables selected from the group consisting of expense ratio, duration, average maturity, credit score, market capitalization, asset default probability, distribution frequency per year, z statistic score, multifactor aggregate z score, momentum, Sharpe Ratio, Sortino Ratio, Martin Ratio, Ulcer Ratio, Value at Risk, Stutzer Index, Arms Index, Sentiment Index, Market Indices, and Moving Average Indices.

12. The method of claim 1 wherein the optimization problem comprises of information ratio constraint comprising of a numerator that measures the active return by an asset over a benchmark, and a denominator that measures the active risk represented by the asset over the benchmark.

13. The method of claim 1 farther comprising receiving, through a network, financial data related to the assets from a data feed source.

14. The method of claim 13 wherein the network is internet.

15. The method of claim 13 wherein the network is wireless.

16. The method of claim 13 wherein the network is wired.

17. The method of claim 1 wherein the investor is a fund.

18. A system for creating and managing a portfolio of assets comprising:
a processor;
an allocation module configured to use the processor to solve an optimization problem to generate a desired allocation within the portfolio of assets, wherein the optimization problem comprises:
at least one objective function; and
at least two constraints selected from the group consisting of capital availability constraint, volatility constraint, style constraint, correlation constraint, discount constraint, information ratio constraint, diversification constraint, fundamental performance constraint, and miscellaneous constraint; and
a communications module to receive the desired allocation from the allocation module and to request the assets within the portfolio of assets be allocated in accordance with the desired allocation.

19. The system of claim 18, further comprising:
an interface portal configured to receive investment goals and guidelines for the portfolio of assets; and
a conversion module to convert the investment goals and guidelines the at least one objective function and at least two constraints.

20. A computer-readable storage medium containing a set of instructions capable of causing one or more processors to:
solve, using the one or more processors, an optimization problem to generate a desired allocation of assets within the portfolio of assets, the optimization problem comprising:
at least one objective function; and
at least two constraints selected from the group consisting of capital availability constraint, volatility constraint, style constraint, correlation constraint, discount constraint, information ratio constraint, diversification constraint, fundamental performance constraint, and miscellaneous constraint; and
allocate the assets within the portfolio of assets according to the desired allocation of assets.
